(19) United States
(12) Patent Application Publication
(10) Pub. No.: US 2012/0054031 A9
(43) Pub. Date: Mar. 1, 2012

(54) METHOD AND APPARATUS FOR CONDUCTING A TRANSACTION BASED ON BRAND INDIFFERENCE

(76) Inventors: Jay S. Walker, Ridgefield, CT (US); Andrew S. Van Luchene, Norwalk, CT (US); Jonathan Otto, Stamford, CT (US); Magdalena Mik, Greenwich, CT (US); Daniel E. Tedesco, Westport, CT (US); Andrew P. Golden, New York, NY (US); Russell Pratt Sammon, Stamford, CT (US)

(21) Appl. No.: 11/686,077

(22) Filed: Mar. 14, 2007

Related U.S. Application Data
(63) Continuation of application No. 09/540,214, filed on Mar. 31, 2000, now abandoned.
Application No. 09/540,214 is a continuation-in-part of application No. 09/337,906, filed on Jun. 22, 1999, now Pat. No. 6,754,636.
Application No. 09/337,906 is a continuation-in-part of application No. 09/190,744, filed on Nov. 12, 1998, now abandoned.
Application No. 09/190,744 is a continuation-in-part of application No. 08/707,660, filed on Sep. 4, 1996, now Pat. No. 5,794,207.
Application No. 09/337,906 is a continuation-in-part of application No. 09/083,345, filed on May 22, 1998, now abandoned.
Application No. 09/337,906 is a continuation-in-part of application No. 08/889,503, filed on Jul. 8, 1997, now Pat. No. 6,249,772.
Application No. 09/337,906 is a continuation-in-part of application No. 08/889,319, filed on Jul. 8, 1997, now Pat. No. 6,085,169.

(51) Int. Cl. G06Q 30/00

(52) U.S. Cl. 705/14.55; 705/26.41; 705/26.7

(57) ABSTRACT

A method and apparatus allows a customer to indicate his or her brand indifference within a product category, and then receive a benefit for purchasing a product chosen by a third party from within this product category. This method and apparatus is particularly useful in differentiating between brand-loyal or brand-sensitive customers and brand-indifferent customers, and allows manufacturers to price-discriminate between these two types of customers. The method includes a step during which an indication of at least one product or service category of interest is received from a customer or other potential purchaser, a step during which a selection of at least one product or service is made that matches the indicated product or service category, a step during which an indication of the selected product or service is provided to the customer or other potential purchaser or to a device used or accessible by the customer or other potential purchaser, a step during which an indication is received that the customer or other potential purchaser has actually purchased, rented, leased, obtained, etc. the selected product or service, and a step during which a benefit is provided to the customer or purchaser who actually purchased, rented, leased, obtained, etc. the selected product or service, or to some other person or entity designated by the customer or some other person or entity.

### CROSS-REFERENCE TO RELATED APPLICATION

The present application is a continuation of U.S. patent application Ser. No. 09/540,214, entitled “METHOD AND APPARATUS FOR CONDUCTING A TRANSACTION BASED ON BRAND INDIFFERENCE”, filed Mar. 31, 2000, which is a continuation-in-part patent application of U.S. patent application Ser. No. 09/337,906 entitled “PURCHASING SYSTEMS AND METHODS WHEREIN A CUSTOMER TAKES POSSESSION AT A RETAILER OF A PRODUCT PURCHASED USING A COMMUNICATIONS NETWORK”, filed on Jun. 22, 1999.

Each of the above-referenced applications is incorporated by reference herein in its entirety.

### BACKGROUND OF THE INVENTION

1. Field of the Invention

This invention relates generally to a method and apparatus for selling products and services and, more particularly, to a method and apparatus for enabling a customer to indicate brand indifference within a product or service category and then receive a benefit for purchasing a product or service chosen by a third party from within the product or service category.

2. Description of the Prior Art

Retail products are often sold by brands. Different brands of a type of product (e.g., different brands of shampoo) are often produced by different manufacturers, and often represent different sets of product characteristics (e.g., extra body, dandruff control). Many products are priced according to brands (e.g., one brand may be more expensive than another brand due to perceived or actual higher quality). In addition, some manufacturers and suppliers spend hundreds of millions of dollars every year on advertisements that create brand identity, promote their products, and differentiate their brands against competitors' brands. These programs are often successful in convincing customers to base their product purchasing decisions on brands. In general, customers are usually brand-loyal or brand-sensitive or the customers are non-brand-loyal or brand-indifferent for a product or service. A customer may be brand-indifferent for some products or services and brand-loyal for other products or services.

A brand-loyal customer for a product or service generally cares or has a strong preference about what brand of product or service he or she purchases. In contrast, brand-indifferent customers do not care, or do not have a strong preference about what brand of product or service they purchase. At a minimum, a brand-indifferent customer is indifferent between two at least two brands of products or services. For example, a given product category might include five different brands of products. A customer may be brand-indifferent to three of the brands of products but dislike or not prefer the other two brands of products. Thus, the customer would be happy with any of the first three brands of products and is brand-indifferent among them. As another example, many cola drinkers are brand-indifferent as to whether they buy Coke™ or Pepsi™ brand sodas or colas. These brand-indifferent or manufacturer-indifferent cola drinkers are often much more price-sensitive; that is, they will purchase whichever product is least expensive, regardless of whether the product is Coke™ or Pepsi™ brand sodas or colas.

Brand-indifferent customers present an interesting problem for manufacturers and suppliers. While there are many customers who are brand-loyal and are willing to pay high prices for specific brands of products (e.g., Perdue™ brand chicken) or services (e.g., Holiday Inns™ brand hotel services), there are also many customers who are brand-indifferent, generally care much more about the prices of products or services that they buy (e.g., $1.59 per pound, $55.00 per night, etc.), and may be more willing to purchase a generic or non-brand name product or service. Many manufacturers and suppliers have considered lowering their prices to attract these price-sensitive or otherwise brand-indifferent customers. However, doing this would result in revenue being lost from all the brand-loyal customers who are willing to pay higher prices for specific brands. Giving an unnecessary discount to these brand-loyal customers would mean lost revenue.

Thus, there is a need for a method and apparatus for differentiating between brand-indifferent customers and brand-loyal or brand-conscious customers. Such a method and apparatus may also motivate brand-indifferent customers to purchase a specific brand or allow customers to trade brand flexibility for a lower price or other benefit.

### SUMMARY OF THE INVENTION

Accordingly, it is an object of the present invention to provide a method and apparatus for allowing a customer to indicate his or her brand indifference by selecting, indicating or modifying a product or service category, and then receive a benefit for purchasing one or more products or services chosen by a third party or controller from within the selected, indicated or modified product or service category. This method and apparatus is particularly useful in differentiating between brand-sensitive or brand-loyal customers and brand-indifferent customers, and allows manufacturers to price-discriminate between these two types of customers while providing an opportunity to capture brand-indifferent customers or entice such brand-indifferent customers to try selected products and/or services. In some embodiments the method and apparatus will allow a customer to designate or select multiple product and/or service categories, thereby creating a “shopping list” of product and/or service categories.

Additional objects, advantages, and novel features of the invention shall be set forth in part in the description that follows, and in part will become apparent to those skilled in the art upon examination of the following or may be learned by the practice of the invention. The objects and the advantages may be realized and attained by means of the instrumentalities and in combinations particularly pointed out in the appended claims.

To achieve the foregoing and other objects and in accordance with the purposes of the present invention, as embodied and broadly described herein, a method for enabling a purchase of at least one of a product or service includes receiving an indication of a product category including at least two products or a service category including at least two services; selecting one of the at least two products or the at least two services; providing an indication of the selected one of the at least two products or the at least two services; and providing an indication of a benefit based on a purchase of the selected one of the at least two products or the at least two services.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

In the Drawings:

FIG. 1 is a flowchart of a first embodiment of a method in accordance with the present invention;

FIG. 2 is a block diagram of system components for an embodiment of an apparatus usable with the method of FIG. 1;

FIG. 3 is a block diagram of system components for another embodiment of an apparatus usable with the method of FIG. 1;

FIG. 4 is a block diagram illustrating a representative controller of FIGS. 2 and 3;

FIG. 5 is a tabular representation of a possible data structure for the product category database of FIG. 4;

FIG. 6 is a tabular representation of a possible data structure for the product database of FIG. 4;

FIG. 7 is a tabular representation of a possible data structure for the customer database of FIG. 4;

FIG. 8 is a tabular representation of a possible data structure for the retailer database of FIG. 4;

FIG. 9 is a tabular representation of a possible data structure for the agreement database of FIG. 4;

FIG. 10 is a tabular representation of a possible data structure for the transaction database of FIG. 4;

FIG. 11 is a block diagram of system components for customer device of FIGS. 2 and 3 and usable with the method of FIG. 1;

FIG. 12 is a flowchart of a second embodiment of a method in accordance with the present invention that can be used with the systems of FIGS. 2 and 3;

FIG. 13 is a flowchart of a third embodiment of a method in accordance with the present invention that can be used with the systems of FIGS. 2 and 3;

FIG. 14 is a flowchart of a fourth embodiment of a method in accordance with the present invention that can be used with the systems of FIGS. 2 and 3;

FIG. 15 is a flowchart of a fifth embodiment of a method in accordance with the present invention that can be used with the systems of FIGS. 2 and 3; and

FIG. 16 is a flowchart of sixth embodiment of a method in accordance with the present invention that can be used with the systems of FIGS. 2 and 3.

### DETAILED DESCRIPTION OF THE EMBODIMENTS

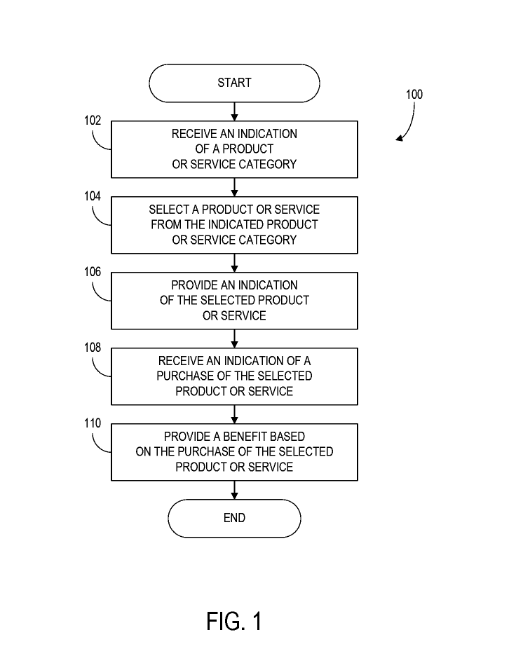

A first embodiment 100 of a method in accordance with the principles of the present invention is illustrated in FIG. 1. The method 100 allows a customer to indicate or designate his or her brand, manufacturer, supplier, product, etc. indifference by selecting, indicating or modifying at least one product or service category, the product category preferably including one or more brands of products and the service category preferably including one or more brands of services. The method 100 then allows the customer or some other entity to receive a benefit for purchasing at least one product or service that falls within the identified or designated product or service category, the product or service being chosen or identified by a computer system, controller, the customer, another person other than the customer, retailer, seller, other third party, etc. In some embodiments, a customer may submit multiple product and/or service categories, thereby creating a “shopping list” of product and/or service categories. The customer will indicate or designate his or her brand, manufacturer, supplier, etc. indifference by selecting, indicating or modifying multiple product and/or service categories in the “shopping list” and preferably will receive a benefit for purchasing at least one product or services that falls within each of the product and/or service categories in the “shopping list,” the products and/or service being chosen or identified by a computer system, controller, the customer, another person, retailer, seller, other third party, etc. In general, a product category is a collection of brands of products and a service category is a collection of brands of services. In some embodiments, each brand of product in a product category may be related (e.g., each may be a brand of shampoo, a brand of radial tire, etc.). As will be discussed in further detail below, product and/or service categories, unrelated or different products may be included in a product category. The term “customer” as used herein should be construed broadly and no specific limitation or definition is implied by use of the term “customer.” In addition, the term “customer” includes any user, shopper, transaction participant, etc.

A very large, and possibly infinite, number of potential product categories exist, including, but not limited to, grocery items, clothing items, gasoline, airline tickets, hardware items, computer hardware or software products, train tickets, lottery tickets, bus tickets, medical products, gambling tokens or chips, drugs, cigarettes, books, videotapes, movie tickets, etc. Similarly, potential service categories include, but are not limited to, travel services, hotel accommodations, insurance, rental cars, mortgages, casino gambling privileges, long distance telephone services, restaurant services, catering services, dry cleaning services, automobile repair services, medical services, movie rentals, etc. Furthermore, the level of detail in the product and service categories can be as detailed or as general as desired. For example, pasta sauce might be designated as a product category. If a further level of detail or classification is desired (i.e., pasta sauce is considered too broad), a thirty-two ounce jar of pasta sauce, a sixteen ounce jar of pasta sauce, and a twelve ounce jar of pasta sauce might each constitute a product category. Product categories may also include a plurality of products of a given type, such as a twelve-pack of soda, or a plurality of products, not necessarily of the same type, such as potato chips, crackers, and pretzels in a “snack” product category.

In some embodiments a customer may be presented with a possible product or service category including a plurality of products or services that are not necessarily identical, similar or even related. For example, a customer may be presented with a list of products (e.g., Marlboro™ cigarettes, Camel™ cigarettes, Virginia Slims™ cigarettes, Red Man™ chewing tobacco, Havana™ cigars, etc.) and then prompted to select or identify which products the customer is interested in purchasing, thereby resulting in a customer selected product category. Note that in one embodiment, the products that the customer selects or identifies for a product category do not have to be of the same type (e.g., cigarettes versus chewing tobacco). However, customers will often choose similar or related products for a product category, since a customer preferably will be willing to purchase any one of the plurality of products that the customer selects for the product category.

In some embodiments, a customer may be allowed to create or define his or her own product or service category by selecting a plurality of products that comprise a product category or a plurality of services that comprise a service category. For example, a customer may create a product category labeled “snacks” and designate that the “snacks” product category will include three different brand name bags of potato chips, two different brand name cans of peanuts, five different brand name cartons of cookies, and three different brand name chocolate bars. By designating these numerous and distinct types of products into a single product category, the customer is agreeing that any one of the products will be acceptable when the customer indicates that he or she wishes to buy a product from his or her “snack” product category. Another method of allowing a customer to create or define his or her own product or service category is to allow the customer to modify a product or service category provided to the customer. In such an example, a customer may reduce or enlarge the size of a product or service category by altering the number of acceptable products or services that fall into or are covered by the product or service category. By selecting a plurality of products from within or that form a product category, a customer may indicate the customer's degree of brand indifference. For example, a first customer may be completely brand-indifferent and be willing to purchase any product from within a product category. However, a second customer may be less brand-indifferent and only willing to purchase certain brands from within the product category. According to one embodiment, a customer may receive a benefit based on the flexibility, size, etc. of a selected or customer created product or service category.

The method 100 illustrated in FIG. 1 includes a step 102 during which an indication, designation, identification, etc. of at least one product and/or service category of interest is received from a customer, another person or entity, a retailer or retailer device, a customer or user device, a computer system, etc.; a step 104 during which a selection of at least one product and/or service is made that matches or falls within the indicated product or service category received during the step 102; a step 106 during which an indication of or other message regarding the product or service selected during the step 104 is provided to the customer or other potential purchaser or entity or to a device used or accessible by the customer or other potential purchaser or entity; a step 108 during which an indication or other message is received indicating that the customer or other potential purchaser or entity has actually purchased, rented, leased, obtained, etc. the product or service selected during the step 104; and a step 110 during which at least one benefit is provided, arranged to be provided, or indicated to the customer or potential purchaser or entity who actually purchased, rented, leased, obtained, etc. the product or service selected during the step 104 or to another entity, person, device, etc. selected or designated by such customer or potential purchaser or entity or selected or designated by another entity, person, device, etc. For purposes of the present application and the claims, the “purchase” of a product or service shall be deemed to include, but not be limited to, the rental, borrowing, paying for, lease, procurement, ordering, purchase, acquisition, and obtaining of such product or service.

The indication or other communication provided by a customer and received during the step 102 preferably is, is part of, or includes a general commitment, agreement, binder or offer to purchase any one or more of a selected product or service that falls within the indicated product or service categories provided in the indication or communication. For example, a customer may submit a “shopping list” of product categories via email that includes one sixteen ounce jar of pasta sauce and one twelve ounce can of chicken noodle soup as product categories without specifying any particular product or brand for the two product categories. Thus, the customer's two selected or indicated product categories in the customer's “shopping list” are a sixteen ounce jar of pasta sauce and a twelve ounce can of chicken noodle soup. The customer is making a general commitment to purchase at least one sixteen ounce jar of pasta sauce and one twelve ounce can of chicken noodle soup. The specific brands and products for the sixteen ounce jar of pasta sauce and the twelve ounce can of chicken noodle soup will be selected by an entity other than the customer during the step 104 and the selection communicated to the customer during the step 106.

The method 100 and each of the steps 102, 104, 106, 108 and 110 will be discussed in further detail below. Another significant advantage of the method 100 is that manufacturers and other suppliers of products or services may habituate customers into buying their products or services or turn a brand-indifferent customer into a brand-loyal customer. For example, a computer system, retailer or other user of the method 100 may always select the same brand of a product for a particular brand-indifferent customer to purchase during multiple uses of the method 100. Subsequently the customer may become accustomed to purchasing this brand of the product and become brand-loyal.

A significant advantage of the method 100 is that the method 100 enables manufacturers or other suppliers of premium brands of products and services to sell products and services to brand-indifferent customers at reduced prices without losing revenue on sales of products and services to brand-loyal customers and without brand-dilution. Thus, the manufacturers and suppliers can entice potential customers of their products to try the products and enlarge their customer base without losing money or providing unnecessary rebates or discounts to existing brand-loyal customers. Potential new customers include brand-indifferent customers and customers who may not be price-conscious, customers who have a predisposition or tendency to price comparison shop or buy generic brand products, customers who are willing to be flexible in brand choice in exchange for lower prices or other benefits, etc. Furthermore, a customer may be brand-loyal for certain products or services and brand-indifferent for other products or services and the method 100 allows customers to maintain such distinctions while receiving or creating benefits during their purchase of products or services for which they are brand indifferent. Thus, a customer may still purchase products for which the customer is brand-loyal while the method allows the customer to receive a benefit when purchasing products for which the customer is brand-indifferent.

A further significant advantage of the method 100 is that customers who are brand-indifferent may receive discounts, rebates, coupons etc. on or for products or services or other benefits as a result of the customers' flexibility in product or service selection. This flexibility allows customers to save money by trading their product and/or service flexibility for a reduced price for or on a product or service or for some other benefit or award. These and other advantages of the method 100 will be discussed in additional detail below.

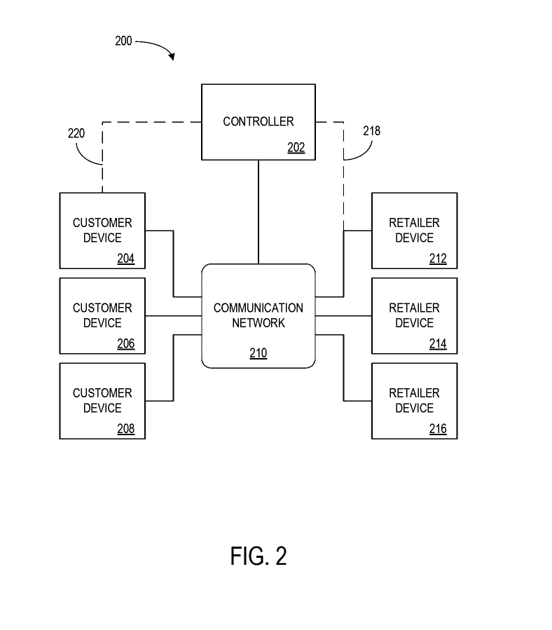

Now referring to FIG. 2, an apparatus or system 200 usable with the method 100 is illustrated. The apparatus 200 includes a controller 202 that may communicate with one or more customer devices 204, 206, 208 via a computer, data, or communications network 210. The controller 202 preferably performs some or all of the steps 102, 104, 106, 108 and 110 of the method 100 and receives customer information, product information, product or service category selections, payment information, indications of purchases of selected products or services, etc. from customers, retailers, other parties, customer devices, etc. The controller 202 may be operated by, for, or on behalf of a single retailer, chain of retailers, collection of retailers, mall, shopping center, one or more manufacturers, one or more suppliers, a government agency, etc. The operation, configuration and use of the controller 202 will be discussed in further detail below.

The customer devices 204, 206 and 208 preferably allow customers to interact with the controller 202 and the remainder of the apparatus 200. The customer devices 204, 206, 208 also enable customers to provide or receive indications of product or service categories, customer identifiers, payment information, purchase confirmations or denials regarding products or services, indications of benefits, indications of products or services, product information, service information, etc. Additionally, the customer devices may enable a customer to receive information, instructions, etc. from the controller 202 or other device. Customer devices may be or include a personal computer, portable computer, mobile or fixed user station, workstation, network terminal or server, telephone, cellular telephone, beeper, kiosk, dumb terminal, personal digital assistant, facsimile machine, etc. A single customer may operate, use or control one or more customer devices and may use different devices and types of devices for different functions. For example, a customer may use one customer device (e.g., a kiosk located in a mall) to provide an indication of a product or service category received during the step 102, a second customer device (e.g., a personal digital assistant) to receive indications of a selected product or service provided during the step 106, and a third customer device (e.g., a cellular telephone) to receive an indication of a benefit or the benefit itself provided during the step 110. As another example, a customer might submit a indication regarding a selection of product and/or service categories via a web site while the customer is at home. The indication may be received via the central controller 202 during the step 102. The customer may receive an indication provided during the step 106 of a product or service selected during the step 104 while the customer is still at home, when the customer arrives at a retailer, whenever the step 104 happens to be completed, etc. The operation, configuration and use of customer devices will be discussed in further detail below.

The communication network 210 might be the Internet, the World Wide Web, or some other public or private computer, data, telephone, or communications network or intranet, as will be described in further detail below. The communication network 210 is only meant to be generally representative of a wire or wireless network, such as a cable, computer or other communication networks for purposes of elaboration and explanation of the present invention and other devices, networks, etc. may be connected to or in communication with the communication network 210 without departing from the scope of the present invention. The communication network 210 is also intended to be representative of, and include all or a part of, the Internet, the World Wide Web, and other privately or publicly operated networks. The communication network 210 can also include other public and/or private wide area networks, local area networks, data communication networks or connections, intranets, routers, satellite links, microwave links, cellular or radio links, fiber optic transmission lines, ISDN lines, T1 lines, DSL, etc.

The system 200 may also include one or more retailer devices, such as the retailer devices 212, 214, 216. The retailer devices 212, 214, 216 may be located in, or associated with, retail stores, a mall or shopping center, a retail chain headquarters, etc. and preferably are used to communicate store, product, service, product category, service category, benefit, customer, purchase or transaction related information to the controller 202 or other devices connected to the communications network 210. For example, a retailer device may be or include a point-of-sale terminal that provides a confirmation or indication to the controller 202 that a customer has actually purchased a product or service selected during the step 104, the confirmation or indication being received during the step 108. As a further example, a retailer device may be or include a database or log of customer purchase transactions that can be accessed or used by the controller 202, the database or log being updated each time a transaction is initiated, completed, etc. Alternatively, the database or log may include information about products, services, customers, transactions, product categories, service categories, customer payments, etc. Information may also be sent back and forth between the controller 202 and retailer devices or retailers to adjust prices for products or services, update information in a database, etc.

The retailer devices 212, 214, 216 may communicate with the controller 202 and/or the customer devices 204, 206, 208 via the communication network 210 or more directly, such as indicated by the dashed line 218 in FIG. 2. The retailer devices 212, 214, 216 may also be connected or otherwise in communication with each other via a local area network. If desired, customer devices may connected directly to the controller 202 as indicated by the dashed line 220 in FIG. 2, or to retailer devices. Pending U.S. patent application Ser. No. 09/348,566 entitled SETTLEMENT SYSTEMS AND METHODS WHEREIN A BUYER TAKES POSSESSION AT A RETAILER OF A PRODUCT PURCHASED USING A COMMUNICATION NETWORK, pending U.S. patent application Ser. No. 09/337,906 entitled PURCHASING SYSTEMS AND METHODS WHEREIN A CUSTOMER TAKES POSSESSION AT A RETAILER OF A PRODUCT PURCHASED USING A COMMUNICATIONS NETWORK, pending U.S. patent application Ser. No. 09/388,723 entitled REDEMPTION SYSTEMS AND METHODS WHEREIN A CUSTOMER TAKES POSSESSION AT A RETAILER OF A PRODUCT PURCHASED USING A COMMUNICATIONS NETWORK, and pending U.S. patent application Ser. No. 08/899,503 entitled SYSTEMS AND METHODS WHEREIN A BUYER PURCHASES A PRODUCT AT A FIRST PRICE AND ACQUIRES THE PRODUCT FROM A MERCHANT THAT OFFERS THE PRODUCT FOR SALE AT A SECOND PRICE, all of which are incorporated herein by reference, each describe various types of retailer, seller, and other devices.

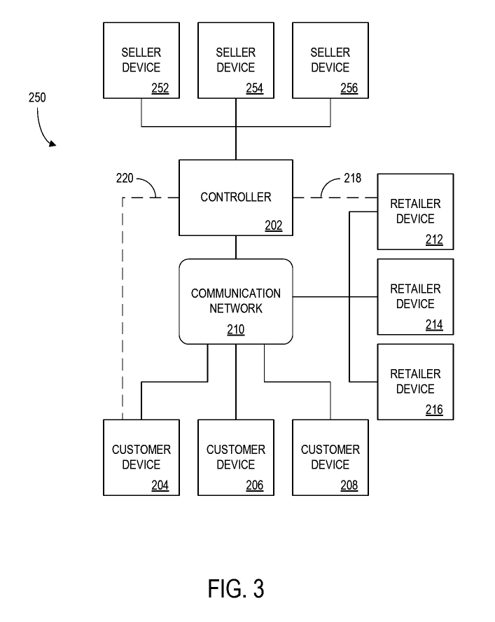

A second embodiment 250 of a system or apparatus usable with the method 100 is illustrated in FIG. 3 and includes the controller 202, customer devices 204, 206, 208, and retailer devices 212, 214, 216 of FIG. 1. In addition, the system 250 includes one or more seller devices, such as the seller devices 252, 254, 256. Typically, a seller device may be located at, associated with, or used by a manufacturer or provider of a good or a service. The seller devices 252, 254, 256 may communicate with, or be connected to, the controller 202 either directly or indirectly through the communication network 210. The seller devices 252, 254, 256 preferably are used to store, provide, and/or update information regarding products or services that are available for sale, rent, lease, etc., such as airline tickets, rental cars, groceries, insurance, mortgages, hotel rooms, books, tires, etc. The seller devices 252, 254, 256 may also be connected or otherwise in communication with each other via a local area network and may include or be a database of information, a server, a web site, etc. If desired, a retailer device can also function as, or at least perform some of the functions of, a seller device, and vice versa.

Now referring again to FIG. 1, the method 100 and the steps 102, 104, 106, 108 and 110 will be discussed in more detail in relation to the system 200 illustrated in FIG. 2 and the system 250 illustrated in FIG. 3. As previously discussed above, the method 100 preferably includes a step 102 during which an indication, identification, designation, selection, communication, etc. of one or more product or service categories is received by a customer device, the controller 202, or some other device. A customer may provide the indication via a customer device, such as the customer device 204 or some other device, via a World Wide Web site or World Wide Web site page, etc. Such an indication received during the step 102 may comprise or take the form of a response to a prompt from a World Wide Web site or page, an email message, a voice message, a facsimile transmission, a cellular telephone call, etc.

For example, a customer may provide the indication received during the step 102 by logging onto or accessing a World Wide Web site or page, by sending or forwarding an email message, by telephone, facsimile machine, etc. If desired, the customer may select one or more product and/or service categories from a list or menu of product and/or service categories presented, sent, or displayed to the customer. A list of acceptable or available product or service categories may be provided to the customer in advance or, alternatively, just before the customer makes or provides his indications of one or more product or service categories. Additionally, the customer may specify when a list of acceptable or available product and/or service categories is to be mailed, emailed, or otherwise provided to the customer. For example, a customer who regularly grocery shops on Wednesday mornings may request that an updated or current list of available product and/or service categories be emailed to the customer on Tuesday afternoons so that the customer can plan, make and provide product or service category selections and indications, and shop accordingly.

By selecting, modifying or indicating a product or service category, and not a single specific brand name or manufacturer, supplier, etc. of a product or service, in an indication provided by a customer and received during the step 102, the customer is indicating his or her brand indifference for products or services in the designated categories. For example, a customer designating a sixteen ounce jar of pasta sauce as a product category is indicating that the customer does not have a preference, or is at least willing to be flexible, regarding which brand (i.e., Ragu™, Prego™, Heinz™, etc.) of sixteen ounce jar of pasta sauce the customer will purchase. Thus, the customer is brand-indifferent with regard to a sixteen ounce jar of pasta sauce and is indicating a willingness to trade flexibility for a lower price or other benefit. As another example, the customer may indicate that the customer is willing to purchase any twenty ounce bag of potato chips, whether it be produced by Ruffles, Wise, Lays, Snyder's, etc. Thus, the customer is indicating a brand flexibility with regard to potato chips and a willingness to exchange brand flexibility for a lower price or other benefit.

In some embodiments, a customer may provide more than one product or service category such that the customer is providing or submitting a “shopping list” of multiple product and/or service categories. That is, the customer may desire to purchase multiple products and/or services from multiple product categories and/or service categories. The customer may select or designate such multiple product and/or service categories in the indication received during the step 102. The “shopping list” embodiments will be discussed in additional detail below.

The indication or communication received during the step 102 may include, constitute, be part of, or sent along with an agreement, offer, binder, obligation, commitment, etc. from the customer to purchase, rent, lease, etc. at least one product in the indicated product category or categories and/or to purchase, obtain, etc. at least one service in the indicated service category or categories. Thus, the indication provided by the customer may bind or obligate the customer to purchase a product or service if a product or service is found or selected during the step 104 that meets or satisfies the product or service category designated by the customer in the indication received during the step 102. Information regarding the indication, agreement, commitment, etc. received during the step 102 may be stored and updated in an agreement database, customer database, and/or a transaction database. The controller 202 preferably has access to, and use of, any such agreement database, customer database, and/or transaction database.

The list of available or acceptable product or service categories provided to a customer may change or be dynamic depending on one or more factors. For example, the acceptability or availability of product or service categories may be dynamic and change over time, perhaps depending on inventory, manufacturer or retailer promotions, expiration date of products or services, availability of a service, cost or price of a product or service, the day of the week, the month of the year, the season of the year, the customer's status as a new user, frequent user, the occurrence of a holiday or other special event, referral source, etc., the availability of coupons, rebates, discounts, the level of a retailer's or manufacturers desire or need to get more customers to try or buy certain products, etc.

If a customer provides an indication or other message received by the controller 202 during a step 102 that does not contain at least one acceptable or available product or service category, the controller 202 may provide a message or indication back to the customer, perhaps via a customer device, that the customer's indicated product or service category is not acceptable or available. In addition, the message or indication provided by the controller 202 to the customer may provide guidelines or suggestions as to what are, or what constitutes, an acceptable and available product or service category. For example, if the customer provided pasta sauce as a product category in the indication received by the controller 202 during the step 102, the controller 202 may respond to the customer with an query or message, perhaps communicated to the customer via a customer device, requesting that the customer choose from a thirty-two ounce jar of pasta sauce, a sixteen ounce jar of pasta sauce, or a twelve ounce jar of pasta sauce as the customer's desired product category. If desired, the controller 202 may determine whether an indication received from a customer during the step 102 includes at least one acceptable product or service category by accessing or using a product/service category database.

The indication from a customer received during the step 102 may also include or be associated with a customer identifier, such as a customer's name, address, social security number, frequent shopper card number, password, mother's maiden name, transaction number, a randomly assigned alphanumeric code, etc. In addition, or as an alternative, the indication from the customer received during the step 102 may also include or be associated with a payment identifier, such as a credit card number, debit card number, store charge card or account number, bank account number, some other financial account number, etc. In some embodiments, the indication received during the step 102 may include a notice or indication that a previously provided payment identifier can be used. In other embodiments, a controller, retailer, etc. may determine a payment identifier to use or to associate with a customer.

If desired, the payment identifier may also function as a customer identifier, and vice versa. The payment identifier may be provided by a customer or used by the controller 202 to provide or even guarantee or obligate payment, such as when the indication received during the step 102 comprises, includes, is part of, or is associated with an agreement, commitment, offer, etc. by the customer to purchase one or more products or services falling within the product and/or service categories designated by the customer in the indication received during the step 102. A payment identifier may also include or be associated with an alternative currency account, such as Beenz™ currency, or some other form of electronic payment.

In some embodiments, a customer may provide a customer identifier and/or a payment identifier at a different time than the category indication received during the step 102 or via a different device than the device used by the customer to provide the category indication received during the step 102.

If the customer does not provide a needed or desired piece of information, either with or as part of the indication received during the step 102, of if the controller 202 does not otherwise have access to a needed piece of information to associate with a customer or an indication received during the step 102, the controller 202 may send a message to, or otherwise communicate with, the customer and request the information. Again, the controller 202 may use the same or a different communication channel to communicate with a customer than the customer used to provide the indication received by the controller 202 during the step 102. Alternatively, once a customer or payment identifier is received by the controller 202, the controller 202 may access or use a customer database and/or a payment database to obtain further information about or associated with the customer.

A customer database may be used to identify a customer for a variety of purposes, including signing up agreements, tracking the customer's purchases, providing benefits to a customer, etc. Information about the customer may also be stored in the customer database, such as the customer's name, mailing address, email address, shopping preferences, telephone number, purchasing history, credit card limit, etc.

During the step 104, the controller 202 or an other device or entity preferably selects at least one product meeting, matching, or falling within each product category designated by a customer in the indication received from the customer during the step 102. Similarly, during the step 104, the controller 202 or another device preferably selects at least one service meeting, matching, or falling within each service category designated by a customer in the indication received from the customer during the step 102. The selection of a specific product or service meeting, matching, or fulfilling a customer's indicated product and/or service category may be dependent on many factors, some of which may be dynamic and change over time. The factors may include inventory information, manufacturer or retailer promotions or subsidies, expiration date of products or services, availability of a service, cost or price of a product or service, the day of the week, the month of the year, the season of the year, the number of product and/or service categories on a customer's “shopping list,” the customer's status as a new user, frequent user, referral source, etc., the availability of coupons, rebates, discounts, the customer's purchasing history, demographic information about the customer, the occurrence of a specific holiday or other event, etc. If desired, the selection process incorporated during the step 104 may also allow manufacturers, suppliers, retailers, sellers, etc. to compete or vie to have their product or services selected during the step 104.

In some embodiments, a score, determination or evaluation of a customer's brand-loyalty or brand-indifference may be computed, identified or used. Such embodiments may recognize that a customer may not be one hundred percent brand-loyal or one hundred percent brand-indifferent. Thus, a continuum of brand-loyalty or brand-indifference may exist for a customer. A customer who is only five percent brand-loyal for a particular product or product type may be easily converted to another brand product or easily convinced to try another brand product. In contrast, a customer who is ninety percent brand-loyal for a particular product or product type may be difficult to convert to another brand product or difficult to convince to try another brand product. The knowledge or score of a customer's brand-loyalty or brand-indifference may be used to help select products or services during the step 104 to try, or decide not to try, to get a customer to try a new or different brand product or service.

In a situation where a manufacturer subsidy or promotion may exist, the controller 202 or other entity or device completing the step 104 may determine if a subsidy, rebate, discount, etc. exists for one or more products and/or services meeting, matching or falling with a product and/or service category designated in the indication received from a customer during the step 102. For example, General Mills Corporation may pay fifty cents to a retailer for each General Mills™ product that a customer buys at the retailer. Thus, if possible, the controller 202 may select a General Mills™ product during the step 104 and pass none, some, or all of the subsidy savings onto the customer.

U.S. Pat. No. 5,794,207, pending U.S. patent application Ser. No. 09/348,566 entitled SETTLEMENT SYSTEMS AND METHODS WHEREIN A BUYER TAKES POSSESSION AT A RETAILER OF A PRODUCT PURCHASED USING A COMMUNICATION NETWORK, pending U.S. patent application Ser. No. 09/337,906 entitled PURCHASING SYSTEMS AND METHODS WHEREIN A CUSTOMER TAKES POSSESSION AT A RETAILER OF A PRODUCT PURCHASED USING A COMMUNICATIONS NETWORK, pending U.S. patent application Ser. No. 09/388,723 entitled REDEMPTION SYSTEMS AND METHODS WHEREIN A CUSTOMER TAKES POSSESSION AT A RETAILER OF A PRODUCT PURCHASED USING A COMMUNICATIONS NETWORK, and pending U.S. patent application Ser. No. 08/899,503 entitled SYSTEMS AND METHODS WHEREIN A BUYER PURCHASES A PRODUCT AT A FIRST PRICE AND ACQUIRES THE PRODUCT FROM A MERCHANT THAT OFFERS THE PRODUCT FOR SALE AT A SECOND PRICE, all of which are incorporated herein by reference, each describe how the controller 202 or other device or entity may select, determine, or identify a product or service based on a product or service category and/or other information.

Information about products and services may be kept or updated in a product/service database and/or in a product/service category database which preferably can be included in, or accessed by, the controller 202. The product/service category database may include information and identifiers describing product or service categories as well as products or services that meet or fall into the product or service categories. By referring to or accessing a product/service category database regarding one or more customer indicated categories, the controller 202 may find information or identifiers as to the products or services available for selection during the step 104 for each customer indicated category. Upon selection of one or more products or services during the step 106, the controller 202 or other device may update a customer database, transaction database, agreement database, etc.

In some situations, no product or service will be identified or located that meets, matches, or otherwise falls within a product or service category selected by a customer in an indication received during the step 102. In such situations, the controller 202 or other device may return to the step 102 and prompt the customer to provide a new indication. The prompt, or a related message to the customer, may or may not indicate to the customer that no appropriate product or service was identified or located matching the customer indicated product or service category. If desired, the prompt or message may be sent during the step 106.

After completion of the step 104, during the step 106 the controller 202, a retailer, a customer device or some other device or entity may provide an indication or message to the customer, a customer device, a retailer, etc. regarding the products and/or services selected during the step 104. The step 106 may be initiated or completed immediately after the completion of the step 104, only when or if a customer arrives at a retailer, at a time designated by a customer, the controller 202, a retailer, when product or service inventory supports or allows a purchase of the selected or identified product or service, etc. The controller 202 may provide such indication or message to the customer from whom an indication was received during the step 102, to a customer or other entity or device selected by the customer or otherwise associated with the customer (which may be determined by referring to a customer database containing such information), to a retail store, collection of retail stores, shopping center, mall, web site, etc. at which the customer may shop, conduct purchase or rental transactions, etc. Furthermore, such indications sent during the step 106 may comprise or take the form of an email message, a voice message, a facsimile transmission, a cellular telephone call, etc. During the step 106, the controller 202 may also provide an indication or message regarding the products and/or services selected during the step 104 to a retailer. Such a message might indicate that an agreement has been made with a customer to purchase one or more products or services at the retailer, that the retailer is now obligated to provide one or more products or services at one or more designated prices to a customer, that the retailer must provide a benefit to a customer, etc.

Once a customer has provided a shopping list of product and/or service categories received during the step 102, the controller 202 or other device or entity may provide an indication during the step 106 as to which, if any, of the customer-indicated product and/or service categories the controller 202 or other device or entity has selected or identified during the step 104. For example, suppose a customer has selected filtered cigarettes, pasta sauce, and potato chips as product categories, and provided an indication of such selections received by the controller 202 during the step 102. Further suppose that the controller 202 could identify and select appropriate products for the filter cigarettes and the pasta sauce product categories, but not the potato chips product category. The indication sent by the controller during the step 106 may then state that the controller 202 could identify and select appropriate products for the filter cigarettes and the pasta sauce product categories and provide the indication of the selected products to the customer, but not the potato chips product category.

The indication sent to the customer during the step 106 may also include any terms or conditions associated with purchasing or otherwise acquiring the products and/or services selected during the step 104 or terms and conditions that compete a formal agreement with the customer to purchase the selected products and/or services. For example, the indication sent to the customer during the step 106 may include additional terms that must be met by the customer, including, but not limited to, which retailer the customer should purchase the selected product(s) or service(s) from (e.g., Giant Eagle, Wegman's, etc.), a list of acceptable retailers, when the customer should purchase or pick-up the selected product(s), the price of the product(s) or service(s), how the customer may receive the selected product(s) (e.g., via home delivery, courier, mail, UPS™ service, etc.), or when the customer may receive a discount, rebate, etc. on the price of the product(s) or service(s). In some embodiments, the customer may be required to purchase the selected product(s) or service(s) before a certain date, or after a certain date, within a specified time frame, in conjunction with the purchase or another product or service, after completion of a qualifying event or action (e.g., filling out a survey), etc. In these embodiments, the controller 202 may select the retailer, date, time, etc. in a similar manner to the step 104 previously discussed above.

After completion of, or as part of, the step 106, the controller 202 preferably receives an indication or message during the step 108 that a customer has purchased, obtained, or arranged or caused the purchase of, one or more of the products or services identified or selected during the step 106. Such indication or other message may come from or be provided by a customer, a customer device, a retailer, a retailer device, a seller, a seller device, a mall, a shopping center, a manufacturer, or some other party or entity. A customer may obtain products or services that are paid for by another party.

If the identified or selected products or services are purchased at different times, at different stores, etc., the controller 202 may receive multiple notices or messages regarding a specific customer or a specific group of products or services selected during the step 106. One or more retailers or the controller 202 might group a number of indications together and send them as a set or in batch to the controller 202. Furthermore, such indications received during the step 108 may comprise or take the form of an email message, a voice message, a facsimile transmission, a cellular telephone call, etc. If no indication is ever received (i.e., the step 108 is not completed), the controller may penalize the customer, as will be discussed in more detail below. Upon completion of the step 108, or as part of the step 108, the controller 202 may update a customer database, transaction database, agreement database, product database, payment database, etc.

Assuming that step 108 is completed (i.e., the controller 202, a retailer, a retailer device, a seller, a seller device or other entity or device receives an indication that a customer has purchased, caused or arranged the purchased of, or otherwise obtained at least one product or service selected during the step 104) during the step 110 one or more benefits preferably are provided to the customer or another person or entity (e.g., a charity) designated by the customer or another person or entity, or an indication is made that the customer or other entity has otherwise received or is entitled to receive a benefit. Possible benefits include a monetary payment that is provided to the customer (e.g., a rebate), a non-monetary amount that is provided to the customer (e.g., frequent flyer miles, long distance calling time, frequent shopper points, etc.), discounts on purchases of future products (e.g., a coupon), one or more products or services that are provided to the customer or a person or entity designated by, or associated with, the customer, a pricing discount on the purchase of a selected product (e.g., ten percent off the regular purchase price), benefits that may be provided to parties other than the customer (e.g., charities) which may be designated by the customer, the controller 202, a retailer, or some other entity.

A benefit may be based on a price or cost of product or service selected during the step 104. Alternatively a benefit may be based on the lowest, highest, etc. cost or price available for any product or service in a category designated by the customer in the indication or message received during the step 102. For example, a customer may select a product category of pasta sauce and four different brand names of pasta sauce may be available for the controller 202 to choose from during the step 104. Regardless of which product the controller 202 selects during the step 104, the customer may receive a benefit by getting the lowest price of any of the four different brand names of pasta sauce available or a discount that is even lower than the lowest price of any of the four different brand names of pasta sauce available. In some embodiments, such as in the shopping list embodiment, multiple benefits may be aggregated together and then provided to a customer or other person at one time.

The selection of a specific benefit to provide may be dependent on many factors, some of which may be dynamic and change over time, perhaps depending on inventory, manufacturer or retailer promotions or subsidies, expiration date of products or services, availability of a service, cost or price of a product or service, the day of the week, the month of the year, the season of the year, the customer's status as a new user, frequent user, referral source, etc., the availability of coupons, rebates, discounts, the customer's purchasing history, demographic information about the customer, the occurrence of a specific holiday or other event, etc.

In some situations where a customer receives a monetary benefit, payment may be provided to the customer in a variety of ways, including crediting money to the customer's credit card account, removing a charge from a customer's credit card account, crediting money to the customer's financial account using a debit card number, crediting, transferring or wiring money to the customer's financial account using a financial account number, mailing cash or a check to the customer, etc.

The type, amount, frequency, duration, etc. of a benefit provided to a customer during the step 110 may be based on a variety of factors, including, the amount of brand indifference provided by a customer (e.g., the number of products in the product category or services in the service category indicated by the customer). According to one embodiment, a customer may receive a greater benefit for selecting a broader product or service category (e.g., a product category including five brands of products instead of two brands of products). While this factor rewards customers who are more brand-indifferent, it may help to create brand loyalty, since customers may be happier to receive products or services in brands that provide greater discounts.

Other factors may include the product or service category that is indicated by the customer (e.g., peanut butter as opposed to bread), the product or service that is selected by the controller 202 (e.g., Prego™ pasta sauce provides a greater benefit than Ragu™ pasta sauce), the availability of subsidies from manufacturers, retailers, malls, etc. and the status of the customer as a new customer, frequent customer, etc. Further factors include the retailer where the customer purchases the product and when the customer purchases the product (e.g., if the customer purchases the product within two weeks, the discount is twenty percent; if the customer waits longer than two weeks to purchase the product, the discount is ten percent).

In some embodiments, benefits may be provided to the customer at different times, including before a selected product or service is purchased or only after the product or service is purchased. It should be noted that in the first case, it may be necessary to include a penalty that is imposed against the customer if the customer does not purchase the product, as will be discussed in further detail below. Also, in some embodiments, a customer may be told what the benefit will be during one of a variety of different times, including when the customer indicates the product or service category, when the controller 202 indicates the selected product or service to the customer during the step 108, when the customer purchases the selected product or service, when the customer receives the benefit (e.g., the benefit is a surprise), etc. Upon completion of the step 110, or as part of the step 110, the controller 202 may update a customer database, transaction database, agreement database, payment database, etc.

While various embodiments and implementations of the method 100 have been discussed above, many other embodiments and implementations of the method 100 are possible within the scope of the present invention and the method 100 should not be limited to only those embodiments and methods discussed above. The different steps 102, 104, 106, 108 and 110 may be completed during a small period of time or over a large period of time.

Either a controller or a retailer may perform one or more of the steps 102, 104, 106, 108 and 110 and a controller and a retailer may work in conjunction, knowingly or unknowingly, intentionally or unintentionally, to perform or complete all of the steps of the method 100. For example, a customer might indicate one or more product or service categories to a controller or retailer device or select from one or more product or service categories provided to the customer by the controller or retailer device. Moreover, either the controller or the retailer device may make product or service selections and/or indicate such product or service selections to the customer. Furthermore, either the controller or the retailer may provide a benefit to the customer directly or indirectly, provide an indication of a benefit to the customer directly or indirectly, arrange to have a benefit or an indication of a benefit provided to the customer, impose a penalty on the customer, arrange to have a penalty imposed on the customer, etc. In addition, an indication of a selected product or service category provided during the step 106 and/or an indication of a benefit or penalty provided during the step 110 may be sent to and/or received by a customer, a customer device, a controller, a retailer, a retailer device, a seller device, another entity or person, etc.

In embodiments where a customer purchases a product or service at or from a retailer, the retailer or a retailer device might indicate such purchase to a controller and either the controller or the retailer may provide a benefit to, or impose a penalty on, the customer. Alternatively, the retailer or retailer device may not indicate such purchase to the controller but may still provide a benefit to, or impose a penalty on, the customer. In other embodiments where a customer purchases a product or service at or from a retailer, the customer may indicate such purchase to a controller and the controller and/or the retailer may provide a benefit to, or impose a penalty on, the customer.

In some embodiments, a retailer may complete the step 102 and receive an indication of a product or service category directly or indirectly from a customer or a controller. The retailer may provide an indication of a product or service category indication received during the step 102 to a controller. Either the retailer or the controller may then complete the step 104. The retailer may then mail or send the selected product to the customer or the customer may purchase or pick up the product at the retailer or another location designated by the controller, customer or retailer. Either the retailer or the controller may provide a benefit to the customer, provide an indication of a benefit to the customer, arrange to have a benefit or indication of a benefit provided to the customer, impose a penalty on the customer, arrange to have a penalty imposed on the customer, etc. If the retailer provides the indication of the selected product or service to the controller, the controller may then provide such indication to the customer and/or the controller may provide a benefit to the customer, provide an indication of a benefit to the customer, arrange to provide a benefit or indication of a benefit to a customer, impose a penalty on the customer, arrange to impose a penalty on the customer, etc.

In some embodiments, a controller may complete the step 102 and receive an indication of a product or service category directly or indirectly from a customer or a retailer. The controller may provide an indication of a product or service category indication received during the step 102 to a retailer. Either the retailer or the controller may then complete the step 104. The retailer may then mail or send the selected product to the customer or the customer may purchase or pick up the product at the retailer or another location designated by the controller, customer or retailer. Either the retailer or the controller may provide a benefit to the customer, provide an indication of a benefit to the customer, arrange to have a benefit or indication of a benefit provided to the customer, impose a penalty on the customer, arrange to impose a penalty on the customer, etc. If the controller provides the indication of the selected product or service to the retailer, the retailer may then provide such indication to the customer and/or the retailer may provide a benefit to the customer, provide an indication of a benefit to the customer, arrange to have a benefit or indication of a benefit provided to the customer, impose a penalty on the customer, arrange to impose a penalty on the customer, etc.

In some embodiments, a retailer may complete the step 104 and select a product or service. The retailer may provide an indication of a product or service selected during the step 104 to a controller and/or to a customer, either directly or indirectly. The retailer may then mail or send the selected product to the customer or the customer may purchase or pick up the product at the retailer or another location designated by the controller, customer or retailer. Either the retailer or the controller may provide a benefit to the customer, provide an indication of a benefit to the customer, arrange to have a benefit or indication of a benefit provided to the customer, impose a penalty on the customer, arrange to have a penalty imposed on the customer, etc. If the retailer provides the indication of the selected product or service to the controller, the controller may then provide such indication to the customer and/or the controller may provide a benefit to the customer, provide an indication of a benefit to the customer, arrange to provide a benefit or indication of a benefit to a customer, impose a penalty on the customer, arrange to impose a penalty on the customer, etc.

In some embodiments, a controller may complete the step 104 and select a product or service. The controller may provide an indication of a product or service selected during the step 104 to a retailer and/or to a customer, either directly or indirectly. The retailer may then mail or send the selected product to the customer or the customer may purchase or pick up the product at the retailer or another location designated by the controller, customer or retailer. Either the retailer or the controller may provide a benefit to the customer, provide an indication of a benefit to the customer, arrange to have a benefit or indication of a benefit provided to the customer, impose a penalty on the customer, arrange to impose a penalty on the customer, etc. If the controller provides the indication of the selected product or service to the retailer, the retailer may then provide such indication to the customer and/or the retailer may provide a benefit to the customer, provide an indication of a benefit to the customer, arrange to have a benefit or indication of a benefit provided to the customer, impose a penalty on the customer, arrange to impose a penalty on the customer, etc.

In some embodiments, a retailer may complete the step 106 and may provide an indication of a product or service selected during the step 104 directly or indirectly to a controller and/or to a customer. The retailer may then mail or send the selected product to the customer or the customer may purchase or pick up the product at the retailer or another location designated by the controller, customer or retailer. Either the retailer or the controller may provide a benefit to the customer, provide an indication of a benefit to the customer, arrange to have a benefit or indication of a benefit provided to the customer, impose a penalty on the customer, arrange to have a penalty imposed on the customer, etc. If the retailer provides the indication of the selected product or service to the controller, the controller may then provide such indication to the customer and/or the controller may provide a benefit to the customer, provide an indication of a benefit to the customer, arrange to provide a benefit or indication of a benefit to a customer, impose a penalty on the customer, arrange to impose a penalty on the customer, etc.

In some embodiments, a controller may complete the step 106 and may provide an indication of a product or service selected during the step 104 directly or indirectly to a retailer and/or to a customer. The retailer may then mail or send the selected product to the customer or the customer may purchase or pick up the product at the retailer or another location designated by the controller, customer or retailer. Either the retailer or the controller may provide a benefit to the customer, provide an indication of a benefit to the customer, arrange to have a benefit or indication of a benefit provided to the customer, impose a penalty on the customer, arrange to have a penalty imposed on the customer, etc. If the retailer provides the indication of the selected product or service to the controller, the controller may then provide such indication to the customer and/or the controller may provide a benefit to the customer, provide an indication of a benefit to the customer, arrange to provide a benefit or indication of a benefit to a customer, impose a penalty on the customer, arrange to impose a penalty on the customer, etc.

In some embodiments, a retailer may complete the step 108 and receive an indication of a purchase of a selected product or service from a controller or a customer, either directly or indirectly. The retailer may then mail or send the selected product to the customer or the customer may purchase or pick up the product at the retailer or another location designated by the controller, customer or retailer. Either the retailer or the controller may provide a benefit to the customer, provide an indication of a benefit to the customer, arrange to have a benefit or indication of a benefit provided to the customer, impose a penalty on the customer, arrange to have a penalty imposed on the customer, etc.

In some embodiments, a controller may complete the step 108 and receive an indication of a purchase of a selected product or service from a retailer or a customer, either directly or indirectly. The retailer may then mail or send the selected product to the customer or the customer may purchase or pick up the product at the retailer or another location designated by the controller, customer or retailer. Either the retailer or the controller may provide a benefit to the customer, provide an indication of a benefit to the customer, arrange to have a benefit or indication of a benefit provided to the customer, impose a penalty on the customer, arrange to have a penalty imposed on the customer, etc.

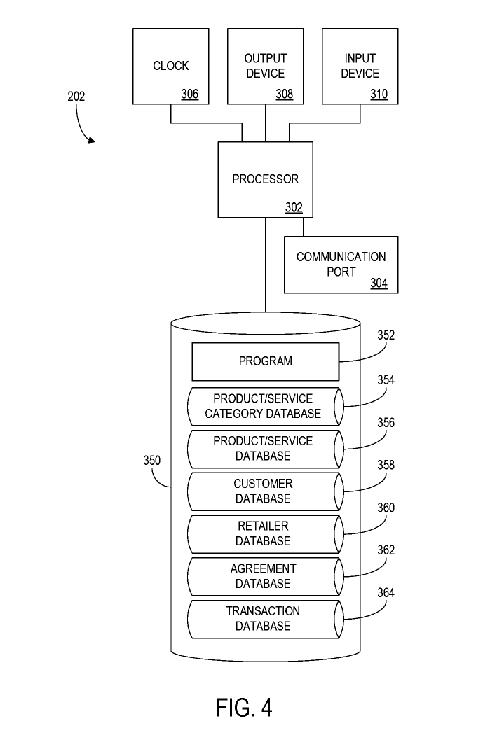

Now referring to FIG. 4, a representative block diagram of a controller or computer, such as the controller or computer 202, is illustrated. The controller 202 may include a processor, microchip, or computer 302 that is in communication with or otherwise uses or includes one or more communication ports 304 for communicating with customer devices, retailer devices, seller devices, and/or other devices. For example, if the controller 202 is connected to or in communication with the retailer device 212 via an Ethernet local area network, the seller device 252 via a cellular telephone network, and the customer device 204 via a Token Ring type local area network, the controller 202 may have an Ethernet adapter as one communication port to allow the controller 202 to communicate with the retailer device, a connection to a cellular telephone network as another communication port to allow the controller 202 to communicate with the retailer device 212, and a Token Ring adapter to allow the controller 202 to communicate with the customer device 204.

The controller 202 may also include an internal clock element 306 to maintain an accurate time and date for the controller 202, create time stamps for indications or other communications generated via the controller 202 or received by the controller 202, etc.

If desired, the controller 202 may include one or more output devices 308 such as a printer, infrared or other transmitter, antenna, audio speaker, display screen or monitor, text to speech converter, etc., as well as one or more input devices 310 such as a bar code reader or other optical scanner, infrared or other receiver, antenna, magnetic stripe reader, image scanner, roller ball, touch pad, joystick, touch screen, microphone, computer keyboard, computer mouse, etc. In addition, the controller 202 may include a voice recognition system or interactive voice response unit as an input device 301 to aid in or enable receiving and processing of customer indications, purchase confirmations, etc. The controller 202 may also include a fingerprint scanner or reader, a retinal scanner, a voice analyzer, or other biometrics data input device as an input device 310 to allow the controller 202 to provide secure access to the controller, identify customers, etc. Including an input device in the controller 202 allows the controller 202 to receive information, indications, and other communications directly from a customer, retailer, seller or other entity or computer system, thereby allowing the controller 202 to function as a customer device, while including an output device in the controller 202 allows the controller 202 to provide product or service selections, benefits, information, and other communications directly to a customer, retailer, seller or other entity. If desired, the controller 202 may also function as a retailer device and/or a seller device.

In addition to the above, the controller 202 may include a memory or data storage device 350 to store information, software, databases, device drivers, customer information, customer agreement or indication information, service information, product information, product category information, service category information, transaction information, payment information, etc. The memory or data storage device 350 preferably comprises an appropriate combination of magnetic, optical and/or semiconductor memory, and may include, for example, Random Access Memory (RAM), Read-Only Memory (ROM), a tape drive, flash memory, a floppy disk drive, a ZIP™ disk drive, a compact disc and/or a hard disk. The processor 302 and the data storage device 350 in the controller 202 may each be, for example: (i) located entirely within a single computer or other computing device; or (ii) connected to or in communication with each other by a remote communication medium, such as a serial port cable, telephone line or radio frequency transceiver. In one embodiment, the controller 202 may comprise one or more computers that are connected to or in communication with a remote server computer for maintaining databases.

A conventional personal computer or workstation with sufficient memory and processing capability may be used as the controller 202. In one embodiment, the controller 202 operates as or includes a web server for an Internet environment. The controller 202 transmits and receives data related to transactions, customer indications, products or services, product or service categories, purchase confirmations, and preferably is capable of high volume transaction processing, performing a significant number of mathematical calculations in processing communications and database searches. A Pentium microprocessor such as the Pentium III, manufactured by Intel Corporation maybe used for the processor 302. Equivalent processors are available from Motorola, Inc., AMD, or Sun Microsystems, Inc. The processor 302 may also comprise one or more microprocessors, computers, computer systems, etc.

While specific implementations and hardware configurations for customer devices, retailer devices, seller devices, user devices, and controllers have been or will be illustrated, it should be noted that other implementations and hardware configurations are possible and that no specific implementation or hardware configuration is needed. Therefore, many different types of implementations or hardware configurations can be used in the systems 200 and 250 and with the method 100 and the methods disclosed herein are not limited to any specific hardware configuration for the systems 200 and 250.

Software may be resident and operating or operational on the controller 202. The software may be stored on the data storage device 350 and may include some or all of the following: a control program 352 for operating the controller 202; a product/service category database 354 for storing information about product or service categories that a customer or user may select; a product/service database 356 for storing information regarding one or more products or services that a customer may buy or that may otherwise be available; a customer database 358 for storing information about one or more customers; a retailer database 360 for storing information regarding retailers, sellers, suppliers, etc. or products or services; an agreement database 362 for storing information regarding agreements, indications, etc. provided by customers and received by customer device and/or the controller 202 during the step 102; and a transaction database 364 for storing information regarding transactions conducted by customers, sellers, retailers, the controller 202, and/or any other part of the systems 200 and 250.

Of course, other databases can also be used, such as a retailer product or service database for storing information regarding retailers of products and/or services, products and/or services, a specific retailer sells or has available and the retail price for the products, etc. Such a retailer product or service database may be updated by the controller 202, a retailer, etc. and may be used by the controller 202, a retailer, etc. to determine or provide a benefit during the step 110 by comparing a retail price of a product purchased to retail prices of other products or services in a selected, identified or modified product or service category.

Each of the databases 354, 356, 358, 360, 362 and 364 and their use and potential data structure will be discussed in more detail below. As will be understood by those skilled in the art, the schematic illustrations and accompanying descriptions of the databases presented herein are exemplary arrangements for stored representations of information. A number of other arrangements may be employed besides those suggested by the tables shown. Similarly, the illustrated entries of the databases represent exemplary information only. Thus, those skilled in the art will understand that the number and content of the entries can be different from those illustrated herein. Not all of the databases 354, 356, 358, 360, and 362 will be used or needed in every embodiment of the method 100 or the systems 200 and 250. Furthermore, some embodiments of the method 100 or the systems 200 and 250 may use none or only some of the databases 354, 356, 358, 360, 362 and 364. Of course, there may be embodiments of the method 100 or the systems 200 and 250 where all of the databases 354, 356, 358, 360, 362 and 364 are used.

The control program 352 may control the processor 302. The processor 302 preferably performs instructions of the control program 352, and thereby operates in accordance with the present invention, and particularly in accordance with the methods described in detail herein. The control program 352 may be stored in a compressed, uncompiled and/or encrypted format. The control program 352 furthermore includes program elements that may be necessary, such as an operating system, a database management system and device drivers for allowing the processor 302 to interface with peripheral devices, databases, etc. Appropriate program elements are known to those skilled in the art, and need not be described in detail herein. According to an embodiment of the present invention, the instructions of the control program 352 may be read into a main memory from another computer-readable medium, such as from a ROM to RAM. Execution of sequences of the instructions in the control program 352 causes the processor 302 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

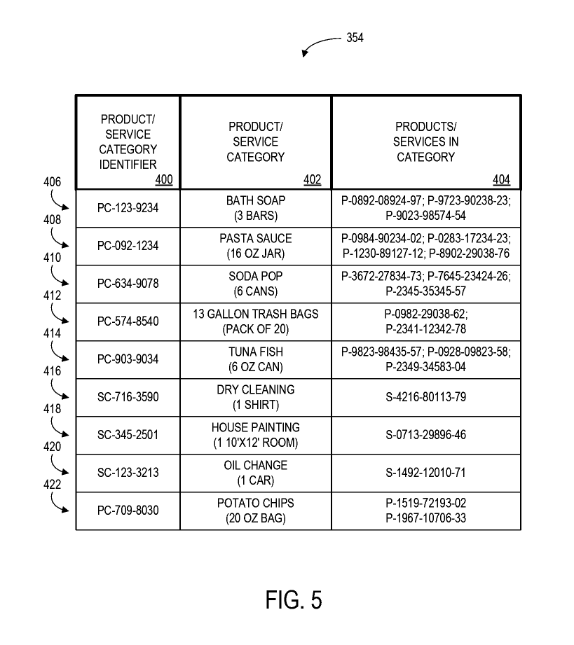

As previously discussed above, the product/service category database 354 can be used to store information and data regarding one or more product categories or service categories that a customer may list or describe in the indication received by the controller 202 during the step 102. The product/service category database 354 may be used, accessed, and/or updated by the controller 202 during use of the method 100. A tabular representation of a possible implementation of, or data structure for, the product/service category database 354 is illustrated in FIG. 5. While the product/service category database 354 illustrated in FIG. 5 is directed to grocery items, it will be appreciated that the product/service category database 354 may include information regarding any type or category of product and/or service.

The product/service category database 354 preferably includes a product/service category identifier field 400 which may contain identifiers or other identifying information for product and/or service categories, a product/service category field 402 which may contain descriptive information for the product and/or service categories identified in the field 400, and a products/services in category field 404 which may contain a description or other identifying information for products or services which fall into the product categories identified in the field 400. For example, the product category identified as “PC-123-9234” in the field 400 is for three bar bath soap and includes three products identified by the product identifiers “P-0892-08924-97,” “P-9723-90238-23” and “P-9023-98574-54” in the field 404 The service category identified as “SC-716-3590” in the field 400 is for dry cleaning services and includes the service identified by the service identifier “S-0713-29896-46” in the field 404.

While the product/service category database 354 illustrated in FIG. 5 provides information for six product categories 406, 408, 410, 412, 414 and 422 identified by the product category identifiers “PC-123-9234,” “PC-092-1234,” “PC-634-9078,” “PC-574-8540,” “PC-903-9034” and “PC-709-8030,” respectively, and three service categories 416, 418, 420 identified by the service category identifiers “SC-716-3590,” “SC-345-2581” and “SC-123-3213,” respectively, in the product/service category identifier field 400, there is no limit to the number of product or service categories for which information can be stored in the product/service category database 354 and different fields may be used in the product/service category database 354.

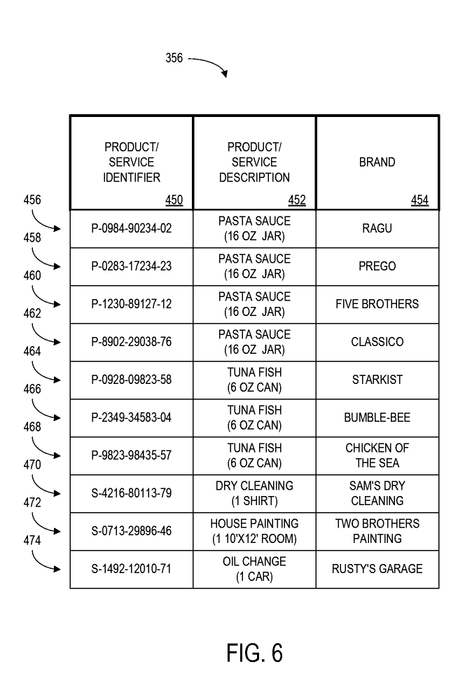

As previously discussed above, the product/services database 356 can be used to store information and data regarding one or more products or services. The product/service database 356 may be used, accessed, and/or updated by the controller 202 during use of the method 100. A tabular representation of a possible implementation of, or data structure for, the product/service database 356 is illustrated in FIG. 6. While the product/service database 356 illustrated in FIG. 6 is directed to grocery items and person services such as drying cleaning and house painting, it will be appreciated that the product/service database 356 may include information regarding any product and/or service.

The product/service database 356 preferably includes a product/serve identifier field 450 which may contain identifiers or other identifying information for one or more products or services, a product/service description field 452 which may contain descriptive or other information regarding the products and/or services identified in the field 450, and a brand or manufacturer field 454 which may contain brand, trademark, service mark, manufacturer or supplier, or other information regarding the products and/or services identified in the field 450. For example, the product identified as “P-0984-90234-02” in the field 450 is a sixteen ounce jar of pasta sauce sold under the brand name or trademark “Ragu” as indicated in the field 454. The service identified as “S-4216-0113-79” in the field 450 is dry cleaning of one shirt by “SAM'S DRY CLEANING” as indicated in the field 454.

While the product/service database 356 illustrated in FIG. 6 provides information for seven products 456, 458, 460, 462, 464, 466 and 468 identified by the product identifiers “P-0984-90234-02,” “P-0283-17234-23,” “P-1230-89127-12,” “P-8902-29038-76,” “P-0928-09823-58,” “P-2349-34583-04” and “P-9823-98435-57,” respectively, and three services 470, 472, 474 identified by the service identifiers “S-4216-80113-79,” “S-0713-29896-46” and “S-1492-12010-71,” respectively, in the product/service identifier field 450, there is no limit to the number of products or services for which information can be stored in the product/service database 356 and different fields may be used in the product/service database 356.

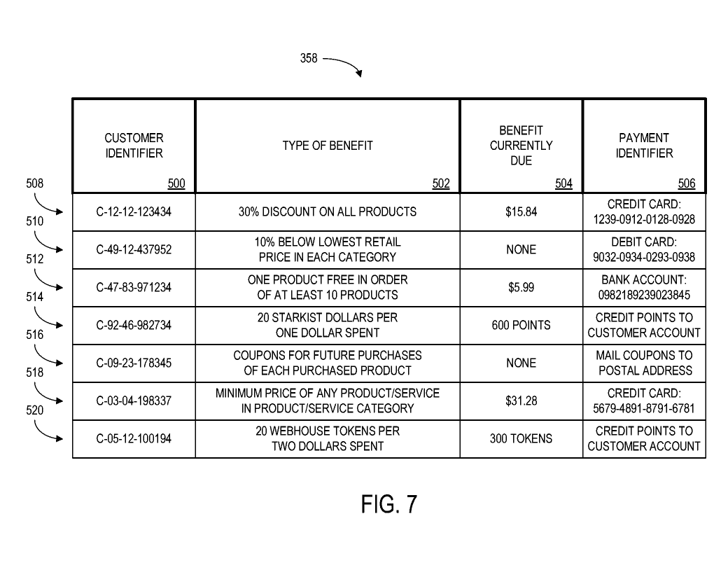

As previously discussed above, the customer database 358 can be used to store information and data regarding customers or potential customers. The customer database 358 may be used, accessed, and/or updated by the controller 202 during the method 100. A tabular representation of a possible implementation of, or data structure for, the customer database 358 is illustrated in FIG. 7.

The customer database 500 preferably includes a customer identifier field 500 which may contain identifiers or other identifying information for customers, potential customers, etc., a type of benefit field 502 which may contain descriptive information regarding benefits provided or to be provided to the customers identified in the field 500, a benefit currently due field 504 which may contain information regarding benefits currently due or owed to the customers identified in the field 500, and a payment identifier field 506 which may contain information regarding credit cards, debit cards, frequent shopping cards, bank accounts, addresses, telephone numbers, email addresses, etc. associated with the customers identified in the field 500. For example, the customer identified as “C-12-12-123434” in the field 500 is receiving the benefit of thirty percent off all products and is currently owed or entitled to receive a benefit of $15.84, as indicated in the fields 502 and 504. The customer identified as “C-12-12-123434” in the field 500 also is associated with, has, or otherwise uses the credit card identified by the credit card number “1239-0912-0128-0928” as indicated in the field 506.

While the customer database 358 illustrated in FIG. 7 provides information for five customers 508, 510, 512, 514, 516, 518 and 520 identified by the customer identifiers “C-12-12-123434,” “C-49-12-437952,” “C-47-83-971234,” “C-92-46-982734,” “C-09-23-178345,” “C-03-04-196337” and “C-05-12-100194,” respectively, in the customer identifier field 500, there is no limit to the number of customers for which information can be stored in the customer database 358 and different fields may be used in the customer database 358.

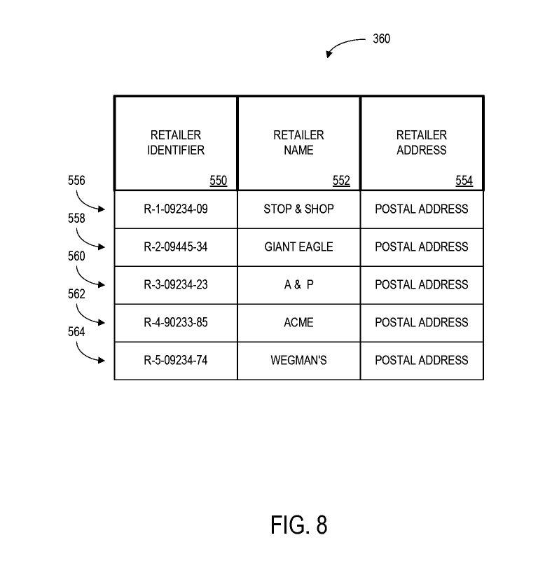

As previously discussed above, the retailer database 360 can be used to store information and data regarding retailers or other sellers, suppliers, etc. of products and services. The retailer database 360 may be used, accessed, and/or updated by the controller 202 during the method 100. A tabular representation of a possible implementation of, or data structure for, the retailer database 360 is illustrated in FIG. 8.

The retailer database 550 preferably includes a retailer identifier field 500 which may contain identifiers or other identifying information for retailers, a retailer name field 552 which may contain descriptive, name, or other information for the retailers identified in the field 550, and a retailer address field 554 which may contain address, telephone, facsimile, email, web site, contact, or other information for the retailers identified in the field 550.

While the retailer database 360 illustrated in FIG. 8 provides information for five retailers 556, 558, 560, 562 and 564 identified by the retailer identifiers “R-1-09234-09,” “R-2-09445-34,” “R-3-09234-23,” “R-4-90233-85” and “R-5-09234-74,” respectively, in the retailer identifier field 550, there is no limit to the number of retailers, sellers, suppliers, etc. for which information can be stored in the retailer database 360 and different fields may be used in the retailer database 360.

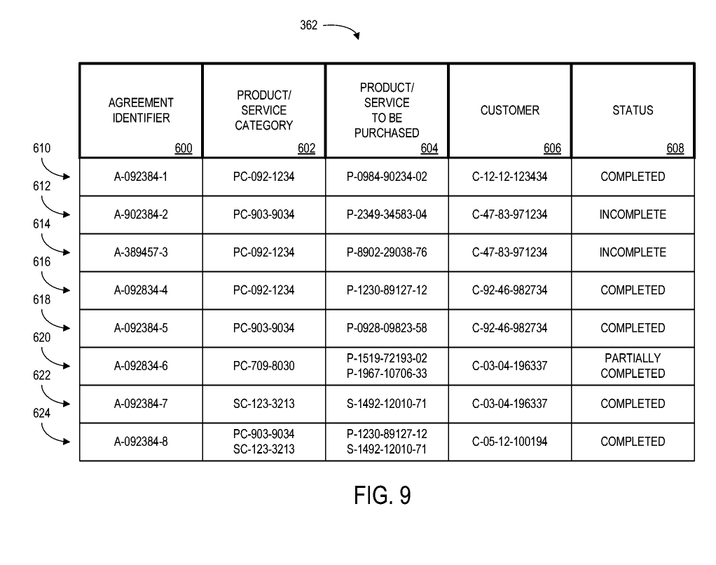

As previously discussed above, the agreement database 362 can be used to store information and data regarding agreements or purchases made by customers, including any agreements or indications that are received during the step 102. The agreement database 362 may be used, accessed, and/or updated by the controller 202 during the method 100. A tabular representation of a possible implementation of, or data structure for, the agreement database 362 is illustrated in FIG. 9.

The agreement database 362 preferably includes an agreement identifier field 600, which may contain identifiers or other identifying information regarding agreements or other indications made by customers or otherwise received during the step 102, a product/service category field 602 which may contain information regarding one or more product or service categories associated with the agreements identified in the field 600, a product/service to be purchased field 604 which may contain descriptive or identifying information regarding one or more products or services falling within the product or service categories listed in the field 602 for the agreements identified in the field 600, a customer field 606 which may contain customer identifiers or other information for customers making or otherwise associated with the agreements identified in the field 600, and a status field 608 which may contain information regarding the status, standing, position, etc. of the agreements identified in the field 600. For example, the agreement identified as “A-092384-1” in the agreement identifier field 600 is associated with the product category “PC-092-1234,” as indicated in the field 602, came from the customer identified as “C-12-12-123434” in the field 606, and has been completed, as indicated in the field 608. The product category “PC-092-1234” includes the product “P-0984-90234-02,” as indicated in the field 604. The agreement identified as “A-092384-7” in the agreement identifier field 600 is associated with the service category “SC-123-3213,” as indicated in the field 602, came from the customer identified as “C-03-04-196337” in the field 606, and has been completed, as indicated in the field 608. The service category “SC-123-3213” includes the service “S-1492-12010-71,” as indicated in the field 604. In some embodiments, a single agreement may be associated with one or more products or services, as illustrated by the agreements “A-092384-6” and “A-092384-8” illustrated in the agreement database 362. If desired, the agreement database 362 may also include a quantity field providing information regarding the quantity or amount of any product or service listed in the field 604.

While the agreement database 362 illustrated in FIG. 9 provides information for eight agreements 610, 612, 614, 616, 618, 620, 622 and 624 identified by the agreement identifiers “A-092384-1,” “A-902384-2,” “A-389457-3,” “A-092834-4,” “A-092385-5,” “A-389457-6,” “A-092834-7” and “A-092385-8,” respectively, in the agreement identifier field 600, there is no limit to the number of agreements, indications, etc. for which information can be stored in the agreement database 362 and different fields may be used in the agreement database 362.

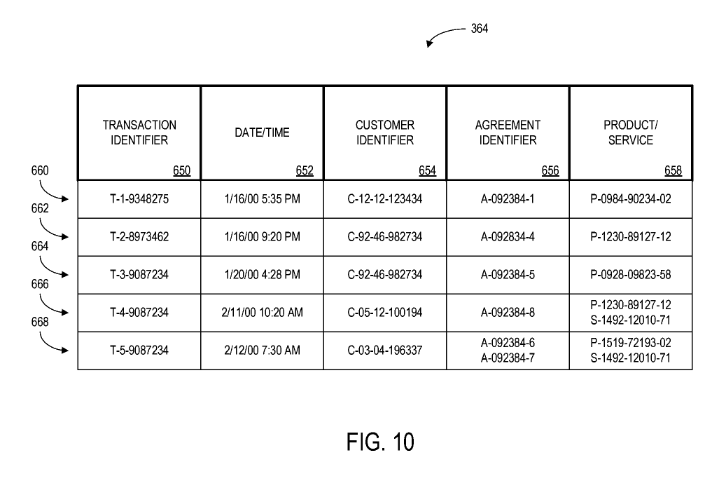

As previously discussed above, the transaction database 364 can be used to store information and data regarding purchases, rentals, leases, etc. of products and/or services that have been made, or are to be made, by customers. The transaction database 364 may be used, accessed, and/or updated by the controller 202, a retailer device, a seller device, a customer device, etc. during the method 100. A tabular representation of a possible implementation of, or data structure for, the transaction database 364 is illustrated in FIG. 10.

The transaction database 364 preferably includes a transaction identifier field 364 which may contain identifiers or other identifying information for transactions completed by a customer, a customer device, a retailer device, a seller device, the controller 202, etc., a date/time field 652 which may contain date and time information for the transactions identified in the field 650, a customer identifier field 654 which may contain information regarding one or more customers initiating, completing, or otherwise associated with the transactions identified in the field 650, an agreement identifier field 656 which may contain information regarding one or more agreements, offers, indications, etc. associated with the transactions identified in the field 650, and a product/service field 658 which may contain information regarding one or more products or services associated with the transactions identified in the field 650. For example, the transaction identified as “T-1-9348275” in the field 650 occurred at 5:35 p.m. on Jan. 16, 2000, and was initiated or completed by, or otherwise associated with, the customer identified as “C-12-12-123434” in the field 654. Furthermore, the transaction identified as “T-1-9348275” in the field 650 is associated with the agreement identified as “A-092384-1” in the field 656, which may have been received by the controller 202 during an implementation of the step 102 and which is associated with the product identified as “P-0984-90234-02” in the field 658. Transactions may be associated with more than one agreement, as indicated by the transaction identified as “T-5-4263108” in the field 650 in the transaction database 364. If desired, the transaction database 364 may also include fields or information for quantity units for the products or services listed in the field 658, one or more prices or costs associated with the transactions identified in the field 650. In addition, the transaction database 34 may also include information for transactions for which no agreement identifier is available or has been ascertained.

While the transaction database 364 illustrated in FIG. 10 provides information for five transactions 660, 662, 664, 666 and 668 identified by the transaction identifiers “T-1-9348275,” “T-2-8973462,” “T-3-9087234,” “T-4-7165932” and “T-5-4263108,” respectively, in the transaction identifier field 650, there is no limit to the number of transactions for which information can be stored in the transaction database 364 and different fields may be used in the transaction database 364.

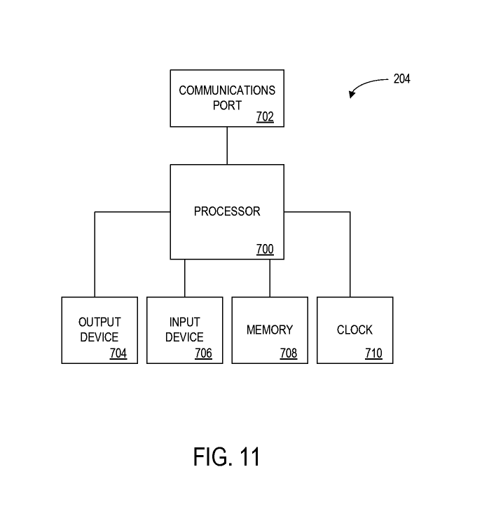

Now referring to FIG. 11, a representative block diagram of a customer device, such as the customer device 204, is illustrated. The customer device 204 may include a processor, microchip, or computer 700 that is in communication with or otherwise uses or includes one or more communication ports 702 for communicating with the controller 202, seller devices, retailer devices and/or other devices. For example, the customer device 204 may have an infrared or other transmitter as one communication port to allow the customer device 204 to communicate with the controller 204. Alternatively, if the customer device 204 is connected to or in communication with the controller 202 via an Ethernet local area network, the customer device 204 preferably will include an Ethernet adapter as a communication port to allow the customer device 204 to communicate with the controller 202.

The customer device 204 may include one or more output devices 704 for conveying information, such as a printer, audio speaker, infrared or other transmitter, antenna, display screen or monitor, text to speech converter, etc. to provide information, indications, and communications from the controller 202, retailer device, seller device, etc. to a customer, as well as one or more input devices 706 for receiving information, such as a bar code reader or other optical scanner, infrared or other receiver, antenna, magnetic stripe reader, image scanner, roller ball, touch pad, joystick, touch screen, microphone, computer keyboard, computer mouse, etc. to enable a customer to provide agreements, purchase confirmations, indications, and other information to the customer device 204, the controller 202, and the systems 200 and 205. A customer device 204 may include a voice recognition system or interactive voice response unit as an input device 706 to aid in receiving and processing agreements, purchase confirmations, customer identifications, indications, etc. The customer device 204 may also include a fingerprint scanner or reader, a retinal scanner, a voice analyzer, or other biometrics data input device as an input device 706 to allow the customer device 204 to provide or enter a customer identifier.

In addition to the above, the customer device 204 may include a memory or data storage device 708 to store information, software, databases, device drivers, customer information, customer identifications, agreements, product or service information or selections, product category or service category information, etc. The memory or data storage device 708 preferably comprises an appropriate combination of magnetic, optical and/or semiconductor memory, and may include, for example, Random Access Memory (RAM), Read-Only Memory (ROM), a tape drive, flash memory, a floppy disk drive, a ZIP™ disk drive, a compact disc and/or a hard disk.

The customer device 204 may also include an internal clock element 710 to maintain an accurate time and date for the customer device 204, create time stamps for information, indications, product selections, purchase confirmations, etc. generated or received via the customer device 204, etc. Such a clock element 710 may be used to create time stamps when, for example, a customer is creating or providing multiple agreements received during multiple implementations of the step 102. If the customer desires that the agreements be processed in chronological order by the controller 202, the time stamps provide a way of ordering the agreements received by the controller 202.

As previously discussed above, possible customer devices include a personal computer, network terminal or server, telephone, beeper, kiosk, dumb terminal, personal digital assistant, facsimile machine, etc. If desired, the customer device 204 may also function as a seller device, a retailer device, and/or the controller 202.

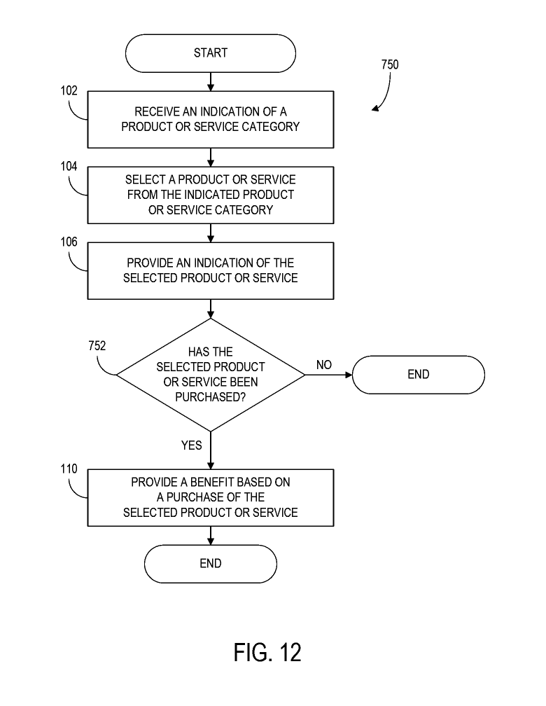

Now referring to FIG. 12, a second embodiment 750 of a method in accordance with the present invention is illustrated. The method 750 can be used with the systems 200 and 250. The method 750 may be used when a specific or separate step is needed to determine if a product or service has been purchased that creates an entitlement of a benefit to a customer or some other person or entity. The method 750 includes the steps 102, 104, 106 and 110 previously described above. In addition, the method 750 includes a step 752 during which a determination is made after before the step 110 as to whether the customer or another person or entity has obtained, purchased, or caused or arranged the purchase of, the product or service selected during the step 104. If the determination made during the step 752 is affirmative, the method 750 preferably proceeds to the step 110 as previously discussed above. If the determination made during the step 752 is negative, the method 750 preferably ends. All or some of the steps in the method 750 may be completed by the controller 202, a retailer, a retailer device, a customer device, some other device or entity, etc.

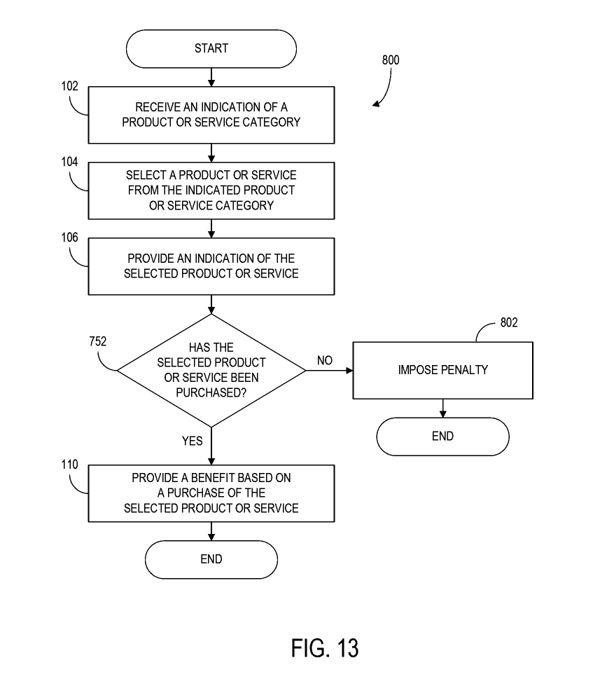

Now referring to FIG. 13, a third embodiment 800 of a method in accordance with the present invention is illustrated. The method 800 can be used with the systems 200 and 250 and for imposing a penalty if a product or service selected during the step 104 is not later purchased. The method 800 includes the steps 102, 104, 106, 110 and 752 previously described above. In addition, the method 800 includes a step 802 during which a penalty is levied or applied against the customer or another person or entity if the determination made during the step 752 is negative (e.g., a customer backed out of or possibly reneged on an agreement or commitment made by the customer to purchase the product or service selected during the step 104). Levying or imposing a penalty against a customer or another person or entity may be necessary to avoid a number of different methods of cheating the method 100. For example, a customer may not be brand-indifferent within a product category (i.e., the customer is brand-loyal and wants a particular brand). The customer may keep submitting or indications for product or service categories, all of which will be received during one or more implementations of the step 102, until the controller 202 selects the product or service during the step 104 that the customer wants. The customer then disregards any agreements that the customer has made for products or services that the customer does not want. Cheating by a customer or unfair advantage being taken by a customer may be prevented by imposing a penalty on the customer who does not purchase a product or service that the customer agreed to purchase.

Penalties may also be used to help guarantee to a manufacturer or other supplier that a certain amount or percentage of the manufacturer's or other supplier's products or services will be purchased by customers. As part of imposing a penalty, or as part of a determination as to whether to impose a penalty, the controller 202 may determine if a customer has purchased a non-selected product or service falling within a product or service category designated by the customer in the indication or message received during the step 102.

Possible penalties include monetary penalties that may be charged to a customer's or other person's credit card, debit card, or other financial account or denial of products or services. There are a number of different ways that a customer may be denied products or services. Examples include situations wherein a customer may be denied past or future benefits, a customer may be disallowed from using the services of the controller 202 (e.g., receiving a benefit based on brand indifference), or a customer may be disallowed from purchasing products from at least one retail store. In addition, the next time the customer purchases products or services using the services of the controller 202 or the systems 200, 250, the customer may be required to specify a greater amount of brand indifference (e.g., four products instead of two). Penalties that involve the denial of services may be permanent or temporary. For example, a penalty may expire after two months, after the customer purchases certain products, or after the customer answers a set of survey questions. In addition, penalties may be based on a variety of different factors and imposed at various different times. All or some of the steps in the method 800 may be completed by the controller 202, a retailer, a retailer device, a customer device, some other device or entity, etc.

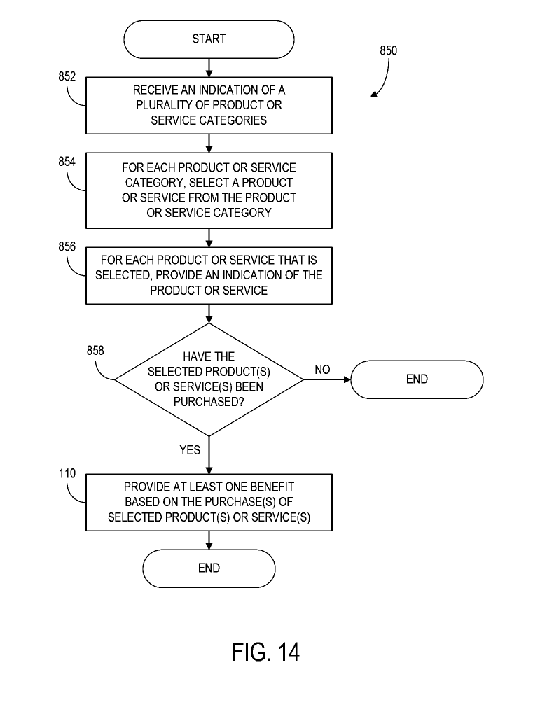

Now referring to FIG. 14, a fourth embodiment 850 of a method in accordance with the present invention is illustrated. The method 850 covers situations where a customer submits a “shopping list” of product and/or service categories and can be used with the systems 200 and 250. The method 850 includes the step 110 previously described above. In addition, the method 850 includes a step 852 during which an indication of a plurality of product or service categories preferably is received from a customer (i.e., the customer is providing a shopping list of product and/or service categories), a customer device, or other person, entity or device. The step 852 is and works very similar to the step 102, the primary difference being that a customer, customer device, other entity, etc. is providing at least two categories of products and/or services. The method 850 also includes a step 854 during which the controller 202, a retailer, a retailer device or another device or entity preferably selects a product or service meeting, matching, or falling within each of the product and/or service categories listed in the indication received during the step 102. The step 854 is and works very similar to the step 104, the primary difference being that the controller 202 or other device is selecting products or services for at least two categories of products and/or services. The method 850 preferably also includes a step 856 during which, for each product or service selected during the step 854, an indication of the selected product and/or service is provided or sent to the customer, to a customer device, a retailer, a retailer device, the controller 202, an other person or entity, other device etc. Each indication may be a separate message or communication or provided as part of a single or multi-part message or communication. Thus, an indication may provide information on one or more selected products and/or one or more selected services. The step 856 is and works very similar to the step 106, the primary difference being that the controller 202 or other device is providing one or more indications for selected products or services in at least two categories of products and/or services.

The method 850 also includes a step 858, during which a determination is made as to whether or not the customer or another entity has purchased, obtained, or caused or arranged the purchase of, one or more of the products and/or services selected during the step 104. The step 858 is and works very similar to the step 752. If the determination made during the step 858 is affirmative, the method 850 preferably proceeds to the step 110 during which at least one benefit is provided to the customer or other entity. If the determination made during the step 858 is negative, the method 850 preferably ends. Alternatively, if the determination made during the step 858 is negative, one or more penalties may be imposed or levied against the customer or some other entity.

In a “shopping list” embodiment, a customer, customer device, etc. preferably selects, identifies or modifies more than one acceptable product category and/or more than one service category. The indication of the selected, identified or modified product and/or service categories is received during the step 852. For example, a customer might indicate a product category of “snacks,” a product category of “radial tires” and a product category of “tennis balls.” The brands of products in the customer's product categories may be chosen by the controller 202 or a retailer, selected or accepted by the customer, etc. During the step 854, the controller 202 or some other device or entity preferably selects or identifies one product in the “snack” product category, one product in the “radial tires” product category and one product in the “tennis balls” product category. During the step 856, one or more indications of selected or identified products preferably is provided to the customer, a customer device, a retailer, a retailer device, the controller 202, etc. During the step 858, one or more indications preferably are received by the controller 202, a retailer, a retailer device, etc. regarding whether the selected or identified products for the three product categories have been purchased. If so, during the step 110, at least one benefit, such a rebate, preferably is provided to the customer, some person designated by the customer, retailer, controller 202, etc. As previously discussed above, a “shopping list” may comprise a standing order by a customer to purchase on or more products or services periodically, each time the customer submits the shopping list, each time the customer arrives at a retailer, etc.

All or some of the steps in the method 800 may be completed by the controller 202, a retailer, a retailer device, a customer device, some other device or entity, etc.

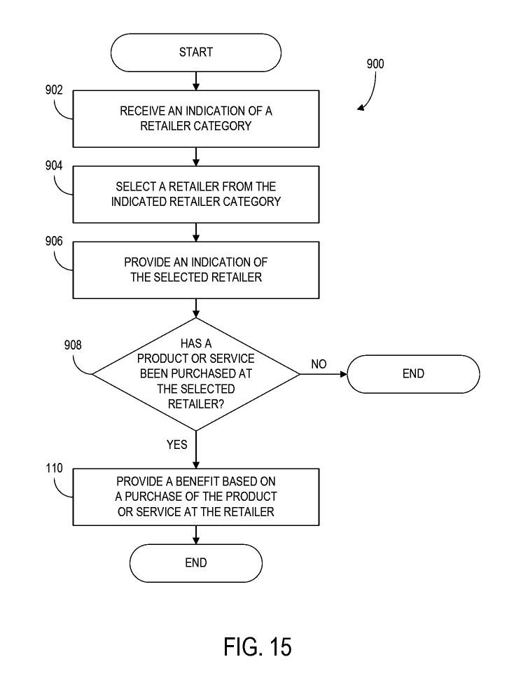

Now referring to FIG. 15, a fifth embodiment 900 of a method in accordance with the present invention is illustrated. The method 900 can be used with the systems 200 and 250 and for allowing a customer to indicate retailer flexibility by selecting, identifying or modifying a retailer category or by indicating two or more acceptable retailers at which a customer is willing to purchase one or more products or services. The method 900 includes the step 110 previously described above. In addition, the method 900 includes a step 902 during which an indication, designation, selection, etc. is received by customer device, the controller 202, a retailer device, etc. regarding an acceptable retailer category or retailer of interest. In such an indication, a customer, customer device, etc. may indicate the store at which the customer would like to purchase or otherwise obtain at least one product or service. The customer may designate a single retailer, a retailer category, a collection of stores, a mall, a chain or stores, etc. The step 902 is analogous to the step 102 previously discussed above.

A retailer category is analogous to a product category in many ways. A retailer category may include a plurality of retailers, such as stores in a particular franchise or chain, drug stores, department stores, stores in a particular mall or shopping center, stores providing certain types of products (e.g., toys, clothing, grocery items, hardware, etc.), stores in a particular geographic area, stores open during a specific time of day, stores willing to take credit cards, stores willing to accept coupons, stores owned or managed by particular people, etc. By designating a retailer category in the indication or message received during the step 902, a customer is indicating, or even promising, to purchase at least one product or service at any one of the retailers in the indicated retailer category.

During a step 904, the controller 202 or another device preferably selects a retailer from the customer indicated retailer category. Such retailer selection preferably is transmitted or otherwise indicated to the customer, customer device, other entity, etc. during a step 906. The steps 904 and 906 are analogous to the steps 104 and 106, respectively, previously discussed above. Additional information may also be indicated to the customer during the step 906, such as when the customer must purchase a product or service from the selected retailer, a benefit that the customer will receive if the customer purchases a product or service from the selected retailer, a penalty that will be levied against the customer is the customer does not purchase a product or service from the selected retailer, etc.

During a step 908, a determination preferably is made as to whether or not the customer or other person or entity did actually purchase a product or service from the retailer selected during the step 904. The step 908 is analogous to the step 752 previously discussed above. If the determination made during the step 908 is affirmative, the method 900 preferably proceeds to the step 110 where at least one benefit is provided to the customer. If the determination made during the step 908 is negative, the method 900 may end. Alternatively, if the determination made during the step 908 is negative, a penalty may be imposed or levied against the customer or another person or entity.

The concepts of the methods 100 and 900 may be combined such that a customer may select or identify both a product or service category and a retailer category in the indication received during the step 102. In such a scenario, the controller 202 may select a product or service during the step 104 that falls within the indicated product or service category and a specific retailer at which the customer is to purchase or otherwise obtain the selected product or service. The controller 202 may then provide a benefit to the customer if the customer purchases the selected product or service at the selected retailer. In addition, the controller 202 may impose a penalty on the customer if the customer does not purchase the selected product or service at the selected retailer.

Some or all of the steps of the method 900 may be completed by the controller 202, a retailer, a retailer device, a customer device, or some other device or entity.

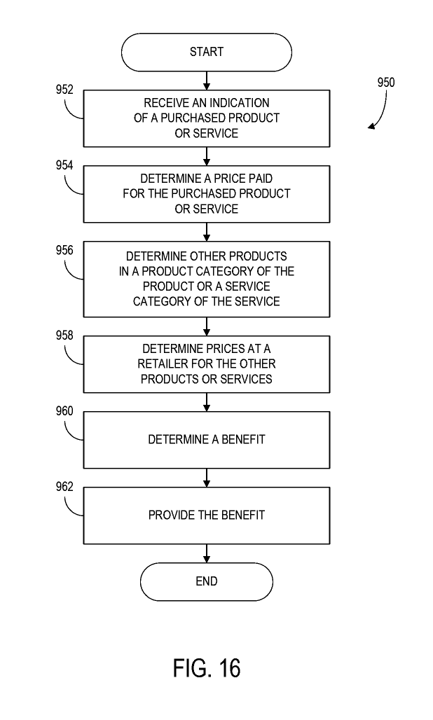

Now referring to FIG. 16, a sixth embodiment 950 of a method in accordance with the present invention is illustrated. The method 950 can be used with the systems 200 and 250 and for determining a benefit when a customer is guaranteed to receive a percentage off the lowest price of a product in a product category, or a service in a service category, regardless of the product or service identified during the step 104. The method 950 includes a step 952 during which an indication is received from a customer, customer device, retailer, retailer device, the controller 202, etc. by a customer device, retailer, retailer device, the controller 202, etc. that a product or service selected during the step 104 has been purchased by or for a customer or some other entity. Such an indication may include an agreement identifier and/or a customer identifier. During a step 954, a price paid for the product or service is determined or accessed, perhaps by querying a retailer product or service database and/or a transaction database that tracks or stores information regarding retail prices for products and/or services. Such a retailer product or service database may be maintained and/or updated by the controller 202, a retailer, etc.

The purchased product or service may fall within a product or service category indicated, selected, or modified during the step 102. During a step 956, other products or services within such indicated, selected or modified product or service category are determined. Such a determination can be made by querying or accessing a product database, a product category database, a service category database, etc. During a step 958, the retail prices for such determined other products preferably are retrieved, calculated or identified. Again, a product or retailer product database may be accessed or queried for such retail price information.

During a step 960 a benefit due a customer or other entity preferably is calculated. The benefit calculation may be performed at different times depending on the embodiment, at or by a point-of-sale terminal during a purchase of a product or service, some time after a purchase of the product or service, directly after the completion of the step 958, etc. As previously discussed above, the method 950 is particularly applicable when a customer has been guaranteed to receive a percentage off the lowest price of a product in a product category, or a service in a service category, regardless of the product or service identified during the step 104. By using the pricing information determined during the steps 954, 956 and 958, a customer may receive the lowest price for any product or service in the product or service category, a discount or percentage off such lowest price, etc. During a step 962, the benefit determined during the step 960 preferably is provided to a customer or to some other entity.

Each of the steps of the method 950 may be performed by the controller 202, a retailer, a retailer device, a customer device, or some other device or entity.

The foregoing description is considered as illustrative only of the principles of the invention. Furthermore, since numerous modifications and changes will readily occur to those skilled in the art, it is not desired to limit the invention to the exact construction and process shown and described above. Accordingly, all suitable modifications and equivalents may be resorted to falling within the scope of the invention as defined by the claims which follow. Further, even though only certain embodiments have been described in detail, those having ordinary skill in the art will certainly understand that many modifications are possible without departing from the teachings thereof. All such modifications are intended to be encompassed within the following claims.

The present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein can be implemented in many different ways using a wide range of programming techniques as well as general purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

While specific implementations and hardware configurations for the systems 200, 250 have been illustrated, it should be noted that other implementations and hardware configurations are possible and that no specific implementation or hardware configuration is needed. Therefore, many different types of implementations or hardware configurations can be used in the systems 200, 250 and with the methods 100, 750, 800, 850, 900 and 950 and the methods disclosed herein are not limited to any specific hardware configuration.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions, or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, ZIP™ disk, flash or optical memory card, microprocessor, solid state memory device, RAM, EPROM, or ROM.

The term “computer-readable medium” as used herein refers to any medium that directly or indirectly participates in providing instructions to a processor for execution. Such a medium may take many forms, including but not limited to, non-volatile media, volatile media, and transmission media. Non-volatile media include, for example, optical or magnetic disks. Volatile media include dynamic random access memory (DRAM), which typically constitutes the main memory. Transmission media include coaxial cables, copper wire and fiber optics, including the wires that comprise a system bus coupled to a processor. Transmission media can also take the form of acoustic, electrical or electromagnetic waves, such as those generated during radio frequency (RF) and infrared (IR) data communications.

The connections or communications between user devices, customer devices, the controller, retailer devices, and seller devices discussed herein is only meant to be generally representative of cable, computer, telephone, or other communication or data networks and methods for purposes of elaboration and explanation of the present. The connections are also intended to be representative of, and include all or a part of, the Internet, the World Wide Web, and other privately or publicly operated networks, including wide area networks, local area networks, data communication networks or connections, intranets, routers, satellite links or networks, microwave links or networks, cellular telephone or radio links, fiber optic transmission lines, ISDN lines, DSL, T1 lines, etc. In addition, as used herein, the terms “computer,” “user device,” “customer device,” “terminal,” “client,” “device” and “client device” are generally interchangeable and are meant to be construed broadly and to include, but not be limited to, all clients, client devices or machines, personal digital assistants and palm top computers, cash registers, terminals, computers, point-of-sale devices, processors, servers, etc. connected or connectable to a computer or data communications network and all devices on which Internet-enabled software, such as the NETSCAPE COMMUNICATOR™ or NAVIGATOR™ browsers, MOSIAC™ browser, or MICROSOFT INTERNET EXPLORER™ browsers, can operate or be run. The term “browser” should also be interpreted as including Internet-enabled software and computer or client software that enables or allows communication over a computer network and Internet-enabled, monitored, or controlled devices such as WebTV™ devices, household appliances, phones, etc.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

We claim:

1. A method, comprising:
receiving an agreement from a customer to purchase a product from a product category, wherein the product category is selected by the customer such that the selection is not indicative of a customer preference among a plurality of products of the product category;
selecting, for the customer, one of the plurality of products from the product category;
determining a value of a benefit to provide;
providing, to the customer, an indication of the selected product and the benefit;
receiving an indication of a purchase of the selected product by the customer; and
providing the benefit based on the purchase.

2. The method of claim 1, wherein the agreement received from the customer to purchase the product includes a purchase price.

3. The method of claim 1, in which selecting one of the plurality of products comprises a retailer selecting the product for the customer.

4. The method of claim 3, wherein the retailer provides the indication of the selected product to the customer.

5. The method of claim 3, further comprising providing an indication to the customer of at least two retail locations of the retailer that have the selected product in inventory.

6. The method of claim 3, further comprising shipping the selected product to the customer.

7. The method of claim 3, in which providing the benefit further comprises basing at least a part of the benefit upon the determination of whether the selected product was purchased from the retailer.

8. The method of claim 1, in which selecting the product depends on at least one of inventory information, a subsidy, a promotion, an expiration date, product availability, cost, a date, a season, the customer's purchasing history, the customer's status, demographic information, or the occurrence of an event.

9. The method of claim 1, wherein the customer creates at least one product category by selecting at least two products and associating the at least two products with a product category.

10. The method of claim 1, in which determining the value of the benefit comprises basing the value on the product category selected by the customer.

11. The method of claim 10, further comprising determining the value based on the number of products in the product category.

12. The method of claim 1, in which determining the value of the benefit comprises basing the value on the product selected for the customer.

13. The method of claim 12, wherein the benefit is greater for a first product of the product category than for a second product of the product category.

14. The method of claim 1, further comprising:
receiving sales information associated with the purchase of the selected product by the customer; and
using the sales information to determine the value of the benefit to provide.

15. The method of claim 14, wherein the sales information is received from a retailer.

16. The method of claim 14, wherein the sales information comprises at least one of the time of purchase of the selected product, and the identity of the retailer where the customer purchased the selected product.

17. The method of claim 1, in which determining the value of the benefit comprises basing the value on at least one of the lowest cost of a product within the category, the highest cost of a product within the category, or the time the purchase occurred.

18. The method of claim 1, in which providing an indication of the selected product further comprises providing purchasing instructions to the customer.

19. The method of claim 1, wherein the indication of a purchase of the selected product is received from at least one of the customer, a customer device, a retailer, a retailer device, a seller, a seller device, or a controller.

20. The method of claim 1, in which providing the benefit comprises providing the benefit to at least one of the customer, another person different from the customer, an entity, another person designated by the customer, or an entity designated by the customer.

21. The method of claim 1, wherein at least one of a manufacturer, a retailer, or a third party provides the benefit.

22. The method of claim 1, further comprising determining a price for the selected product and providing an indication of a price for the selected product.

23. The method of claim 1, further comprising determining a condition of purchase for the selected product.

24. The method of claim 23, further comprising providing an indication of the condition of purchase of the selected product.

25. The method of claim 24, further comprising imposing a penalty if the purchase of the selected product is not completed in accordance with the condition of purchase.

26. The method of claim 1, wherein the agreement is a binding commitment to purchase a product that is selected for the customer.

27. The method of claim 1, in which the benefit is provided by crediting an account of the customer.

28. The method of claim 1, in which the benefit comprises a rebate.

29. The method of claim 28, wherein the rebate comprises an alternate currency.

30. A computer readable medium storing instructions configured to direct a processor to:
receive an agreement from a customer to purchase a product from a product category, wherein the product category is selected by the customer such that the selection is not indicative of a customer preference among a plurality of products of the product category;
select, for the customer, one of the plurality of products from the product category;
determine a value of a benefit to provide;
provide, to the customer, an indication of the selected product and the benefit;
receive an indication of a purchase of the selected product by the customer; and
provide the benefit based on the purchase.

31. The computer readable medium of claim 30, in which the instructions for receiving the agreement comprise instructions configured to direct the processor to obtain a purchase price.

32. The computer readable medium of claim 30, in which the instructions for selecting one of the plurality of products for the customer comprise instructions configured to direct the processor to receive the selection from a retailer.

33. The computer readable medium of claim 32, which further comprises instructions configured to direct the processor to provide an indication to the customer of at least two retail locations of the retailer that have the selected product in inventory.

34. The computer readable medium of claim 32, which further comprises instructions configured to direct the processor to provide customer information to the retailer to enable shipment of the product to the customer.

35. The computer readable medium of claim 32, which further comprises instructions configured to direct the processor to determine at least a part of the benefit based upon whether the selected product was purchased from the retailer.

36. The computer readable medium of claim 30, in which the instructions for selecting the product comprise instructions configured to direct the processor to determine the selection based on at least one of inventory information, a subsidy, a promotion, an expiration date, product availability, cost, a date, a season, the customer's purchasing history, the customer's status, demographic information, or the occurrence of an event.

37. The computer readable medium of claim 30, in which the instructions for receiving the agreement from a customer to purchase a product from a product category further comprises instructions configured to direct the processor to:
receive a customer selection and association of at least two products with a product category;
generate a product category that includes the at least two products; and
associate the product category with the customer.

38. The computer readable medium of claim 30, in which the instructions for determining the value of the benefit comprises instructions configured to direct the processor to determine the value based on the product category selected by the customer.

39. The computer readable medium of claim 38, which further comprises instructions configured to direct the processor to determine the value based on the number of products in the product category.

40. The computer readable medium of claim 30, in which the instructions for determining the value of the benefit comprises instructions configured to direct the processor to determine the value based on the product selected for the customer.

41. The computer readable medium of claim 40, which further comprises instructions configured to direct the processor to determine the value of the benefit based on at least one of a first product of the product category or a second product of the product category, wherein the value is greater for the first product than for the second product.

42. The computer readable medium of claim 30, which further comprises instructions configured to direct the processor to:
receive sales information associated with the purchase of the selected product by the customer; and
determine the value of the benefit to provide based on the sales information.

43. The computer readable medium of claim 42, in which the instructions for receiving the sales information and determining the value of the benefit comprises instructions configured to direct the processor to receive the sales information from a retailer.

44. The computer readable medium of claim 42, in which the instructions for receiving the sales information comprises instructions configured to direct the processor to obtain at least one of the time of purchase of the selected product, and the identity of the retailer where the customer purchased the selected product.

45. The computer readable medium of claim 30, in which the instructions for determining the value of the benefit comprises instructions configured to direct the processor to base the value on at least one of the lowest cost of a product within the category, the highest cost of a product within the category, or the time the purchase occurred.

46. The computer readable medium of claim 30, in which the instructions for providing an indication of the selected product further comprises instructions configured to direct the processor to provide purchasing instructions to the customer.

47. The computer readable medium of claim 30, in which the instructions for receiving the indication of the purchase of the selected product comprises instructions configured to direct the processor to receive the indication from at least one of the customer, a customer device, a retailer, a retailer device, a seller, a seller device, or a controller.

48. The computer readable medium of claim 30, in which the instructions for providing the benefit comprises instructions configured to direct the processor to provide the benefit to at least one of the customer, another person different from the customer, an entity, another person designated by the customer, or an entity designated by the customer.

49. The computer readable medium of claim 30, which further comprises instructions configured to direct the processor to:
determine a price for the selected product; and
provide an indication of the price for the selected product.

50. The computer readable medium of claim 30, which further comprises instructions configured to direct the processor to determine a condition of purchase for the selected product.

51. The computer readable medium of claim 50, which further comprises instructions configured to direct the processor to provide an indication of the condition of purchase of the selected product.

52. The computer readable medium of claim 50, which further comprises instructions configured to direct the processor to impose a penalty if the purchase of the selected product is not completed in accordance with the condition of purchase.

53. The computer readable medium of claim 30, in which the instructions for providing the benefit comprise instructions configured to direct the processor to credit an account of the customer.

54. The computer readable medium of claim 30, in which the instructions for providing the benefit comprise instructions configured to direct the processor to provide a rebate.

55. An apparatus, comprising:
a memory;
a communication port; and
a processor connected to the memory and the communication port, the processor being operative to:
receive an agreement from a customer to purchase a product from a product category, wherein the product category is selected by the customer such that the selection is not indicative of a customer preference among a plurality of products of the product category;
select, for the customer, one of the plurality of products from the product category;
determine a value of a benefit to provide;
provide, to the customer, an indication of the selected product and the benefit;
receive an indication of a purchase of the selected product by the customer; and
provide the benefit based on the purchase.

56. The apparatus of claim 55, further comprising at least one of a clock, an output device, or an input device.

57. The apparatus of claim 55, wherein the memory comprises at least one of a product and service category database, a product and service database, a customer database, a retailer database, an agreement database, or a transaction database.

58. A method, comprising:
receiving, from a customer, a selection of at least two products to form a product category, wherein the products are acceptable alternatives of each other;
receiving an agreement from the customer to purchase at least one product from the product category, wherein the agreement does not include a preference among the products of the product category;
selecting, for the customer, one of products from the product category;
providing an indication of the selected product;
receiving an indication that the customer purchased the selected product; and
providing a benefit.

59. The method of claim 58, in which receiving the selection of at least two products to form a product category further comprises receiving an indication from the customer of at least one product to exclude from the product category.

60. The method of claim 58, in which receiving the agreement comprises receiving an amount that the customer is willing to pay for the product.

61. The method of claim 58, further comprising:
selecting a retailer for the customer from a plurality of retailers offering the product for sale; and
providing an indication of the selected retailer.

62. The method of claim 58, in which selecting one of the plurality of products comprises a retailer selecting the product for the customer.

63. The method of claim 62, wherein the retailer provides the indication of the selected product to the customer.

64. The method of claim 62, further comprising providing an indication to the customer of at least two retail locations of the retailer that have the selected product in inventory.

65. The method of claim 62, further comprising shipping the selected product to the customer.

66. The method of claim 58, in which selecting the product comprises basing the selection on at least one of inventory information, a subsidy, a promotion, an expiration date, product availability, cost, a date, a season, the customer's purchasing history, the customer's status, demographic information, or the occurrence of an event.

67. The method of claim 58, further comprising, after selecting the product from the product category, determining the value of the benefit.

68. The method of claim 67, in which determining the value of the benefit comprises determining the value based on at least one of the product category selected by the customer, the number of products selected, or the particular product selected for, and purchased by, the customer.

69. The method of claim 67, in which determining the value of the benefit comprises determining the value based on at least one of the lowest cost of a product within the category, the highest cost of a product within the category, or the time the purchase occurred.

70. The method of claim 58, in which providing an indication of the selected product further comprises providing purchasing instructions to the customer.

71. The method of claim 58, in which providing the benefit further comprises basing at least a part of the value of the benefit upon the determination of whether the selected product was purchased from the retailer.

72. The method of claim 58, in which providing the benefit comprises providing the benefit to at least one of the customer, another person different from the customer, an entity, another person designated by the customer, or an entity designated by the customer.

73. The method of claim 58, wherein at least one of a manufacturer, a retailer, or a third party provides the benefit.

74. The method of claim 58, further comprising:
determining a condition of purchase for the selected product; and
providing an indication of the condition of purchase of the selected product.

75. The method of claim 74, further comprising imposing a penalty if the purchase of the selected product is not completed in accordance with the condition of purchase.

76. The method of claim 58, in which the benefit comprises a rebate.

77. The method of claim 76, wherein the rebate comprises an alternate currency.

78. A computer readable medium storing instructions configured to direct a processor to:
receive, from a customer, a selection of at least two products to form a product category, wherein the products are acceptable alternatives of each other;
receive an agreement from the customer to purchase at least one product from the product category, wherein the agreement does not include a preference among the products of the product category;
select, for the customer, one of products from the product category;
provide an indication of the selected product;
receive an indication that the customer purchased the selected product; and
provide a benefit.

79. The computer readable medium of claim 78, in which the instructions for receiving the selection of at least two products to form a product category comprise instructions configured to direct the processor to receive an indication from the customer of at least one product to exclude from the product category.

80. The computer readable medium of claim 78, in which the instructions for receiving the agreement comprise instructions configured to direct the processor to receive an amount that the customer is willing to pay for the product.

81. The computer readable medium of claim 78, which further comprises instructions configured to direct the processor to:
select a retailer for the customer from a plurality of retailers offering the product for sale; and
provide an indication of the selected retailer.

82. The computer readable medium of claim 78, in which the instructions for selecting one of the plurality of products for the customer comprise instructions configured to direct the processor to receive the selection of the product from a retailer.

83. The computer readable medium of claim 82, which further comprises instructions configured to direct the processor to provide an indication to the customer of at least two retail locations of the retailer that have the selected product in inventory.

84. The computer readable medium of claim 82, which further comprises instructions configured to direct the processor to provide customer information to the retailer to enable shipment of the product to the customer.

85. The computer readable medium of claim 78, in which the instructions for selecting one of the plurality of products for the customer comprise instructions configured to direct the processor to determine the selection based on at least one of inventory information, a subsidy, a promotion, an expiration date, product availability, cost, a date, a season, the customer's purchasing history, the customer's status, demographic information, or the occurrence of an event.

86. The computer readable medium of claim 78, which further comprises instructions configured to direct the processor to, after selection of the product from the product category, determine the value of the benefit.

87. The computer readable medium of claim 86, in which the instructions for determining the value of the benefit comprise instructions configured to direct the processor to determine the value based on at least one of the product category selected by the customer, the number of products selected, or the particular product selected for, and purchased by, the customer.

88. The computer readable medium of claim 86, in which the instructions for determining the value of the benefit comprise instructions configured to direct the processor to determine the value based on at least one of the lowest cost of a product within the category, the highest cost of a product within the category, or the time the purchase occurred.

89. The computer readable medium of claim 78, in which the instructions for providing an indication of the selected product comprise instructions configured to direct the processor to provide purchasing instructions to the customer.

90. The computer readable medium of claim 78, in which the instructions for providing the benefit comprise instructions configured to direct the processor to base at least a part of the value of the benefit upon the determination of whether the selected product was purchased from the retailer.

91. The computer readable medium of claim 78, in which the instructions for providing the benefit comprise instructions configured to direct the processor to provide the benefit to at least one of the customer, another person different from the customer, an entity, another person designated by the customer, or an entity designated by the customer.

92. The computer readable medium of claim 78, in which the instructions for providing the benefit comprise instructions configured to direct the processor to instruct at least one of a manufacturer, a retailer, or a third party to provide the benefit.

93. The computer readable medium of claim 78, which further comprises instructions configured to direct the processor to:
determine a condition of purchase for the selected product; and
provide an indication of the condition of purchase of the selected product.

94. The computer readable medium of claim 93, which further comprises instructions configured to direct the processor to impose a penalty if the purchase of the selected product is not completed in accordance with the condition of purchase.

95. The computer readable medium of claim 78, in which the instructions for providing the benefit comprise instructions configured to direct the processor to provide a rebate.

96. An apparatus, comprising:
a memory;
a communication port; and
a processor connected to the memory and the communication port, the processor being operative to:
receive, from a customer, a selection of at least two products to form a product category, wherein the products are acceptable alternatives of each other;
receive an agreement from the customer to purchase at least one product from the product category, wherein the agreement does not include a preference among the products of the product category;
select, for the customer, one of products from the product category;
provide an indication of the selected product;
receive an indication that the customer purchased the selected product; and
provide a benefit.

97. The apparatus of claim 96, further comprising at least one of a clock, an output device, or an input device.

98. The apparatus of claim 96, wherein the memory comprises at least one of a product and service category database, a product and service database, a customer database, a retailer database, an agreement database, or a transaction database.
